(19) United States
(12) Patent Application Publication
(10) Pub. No.: US 2008/0264842 A1
(43) Pub. Date: Oct. 30, 2008

(54) DISPOSABLE MICROPURIFICATION CARDS, METHODS, AND SYSTEMS THEREOF

(75) Inventors: Kyle W. Hukari, Dublin, CA (US); Matthew J. Bartosiewicz, Pleasanton, CA (US); Seth R. Stern, Palo Alto, CA (US); Michael C. DeRenzi, San Ramon, CA (US); Fabien M. Van De Graaf, Fremont, CA (US); Jesse B. Thompson, Brentwood, CA (US); Jay A.A. West, Pleasanton, CA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Arcxis Biotechnologies, LLC, Pleasanton, CA (US)

(21) Appl. No.: 11/870,976

(22) Filed: Oct. 11, 2007

Related U.S. Application Data
(60) Provisional application No. 60/829,079, filed on Oct. 11, 2006.
(60) Provisional application No. 60/973,103, filed on Sep. 17, 2007.

(51) Int. Cl. B01D 15/42; B01D 21/30; B01D 35/18

(52) U.S. Cl. 210/137; 210/198.2; 210/181; 210/175

(57) ABSTRACT

Disclosed herein are micropurification cards, systems, systems and methods, backspace. A micropurification cards include a plurality of fluidic components capable of extracting molecules from samples. Samples include biological cells and the extracted molecules include nucleic acids.

### CROSS-REFERENCE TO RELATED APPLICATIONS

This application claims the benefit of U.S. Patent Application Serial No. 60/829,079, filed Oct. 11, 2006, and U.S. Patent Application Serial No. 60/973,103 filed Sep. 17, 2007, the entirety of each application is incorporated by reference herein.

### FIELD OF THE INVENTION

The present invention is related to methods and devices for preparing samples, in particular, to lyse biological cells and to purify cellular macromolecules that reside within them.

### BACKGROUND OF THE INVENTION

Analysis of biological agents depends on the ability to prepare unknown samples for analysis. A major component of sample preparation is lysing and solubilizing biological agents. Sample preparation is complicated by the wide variability in the stability of biological agents to the effects of lysis and solubilization. A variety of techniques have been developed for lysing viruses, eukaryotic, and prokaryotic organisms, including bacterial spores. Examples include chemical and detergent lysis, enzyme treatment, sonication, heating, and glass bead milling. Bacterial spores, for example, are extremely resistant to lysis and solubilization, often requiring a combination of the aforementioned techniques. However, many of these lysis techniques complicate analysis due to the addition of chemical additives or proteins to the samples which interfere with the amplification, labeling or analytical analysis.

Several sample processing techniques have been developed for the use and integration of microfluidic devices. These techniques and microfluidic devices include integrated detergent mediated lysis, laser mediated cell lysing, and electric field mediated lysis. In addition, systems have been developed that allow for the lysis, concentration, purification, and analysis of DNA from E. coli. Many of these systems perform sample processing on relatively labile eukaryotic cell types, and bacteria. The majority of these devices do not have ability to elute the prepared sample to allow downstream analysis. Fewer studies have been directed to rapidly lyse and analyze bacterial spores for microfluidic analysis.

Thus, there is a continuing need to develop sample processing techniques useful for a variety of analyses including, but not limited to, electrophoretic analysis, protein fingerprinting, nucleic acid amplification, i.e., PCR, and hybridization analysis, such as the use of protein and nucleic acid microarrays. Finally, there is also a need to develop disposable and compact card base sample preparation systems that are easy to use and which minimize sample cross-contamination.

### SUMMARY OF THE INVENTION

One aspect of the present invention provides micropurification cards that comprise a plurality of fluidic components capable of extracting molecules from a sample. The plurality of fluidic components of the micropurification cards are substantially oriented in a plane, the plurality of fluidic components comprising: a sample loading inlet, an elution inlet, a lysing region capable of being heated to at least about 90° C. and pressurized to at least about 10 psi greater than the ambient atmospheric pressure to provide a lysed sample. They also include a porous membrane capable of filtering molecules from the lysed sample, a molecule capture region capable of being heated to at least about 40° C., during a analyte binding step and to 95° C. during an elution step, and an elution tip. The sample loading inlet is in fluidic communication with the lysing region, the lysing region being in fluidic communication with the filter, the filter being capable of fluidically communicating one or more molecules to the molecule capture region, and the molecule capture region being in fluidic communication with both the elution inlet and the elution tip.

Systems suitable for preparing samples in one or more micropurification cards at elevated temperatures and pressures are also provided. Systems of the present invention include a sample input fluid connection capable of being fluidically connected under pressure to a sample loading inlet on the micropurification cards (MCP); an elution input fluid connection capable of being fluidically connected under pressure to a sample loading inlet to an elution inlet on the micropurification card; as well as a card holder capable of positionally holding the micropurification card to receive the sample input fluid and elution input fluid connections.

Systems are also provided that are suitable for collecting molecules from samples using disposable micropurification cards at elevated temperatures and pressures. These systems include one or more disposable micropurification cards and systems suitable for preparing samples in sample preparation micropurification cards (MCP). In these systems, the micropurification cards include an injection-molded card comprising a plurality of fluidic components capable of extracting molecules from a sample comprising one or more cells, the plurality of fluidic components comprising a sample loading inlet capable of being in fluidic communication with a lysing region, the lysing region being in fluidic communication with a filter, the filter being capable of fluidically communicating one or more molecules to a molecule capture region, and the molecular capture region being in fluidic communication with an elution inlet and an elution tip. Suitable systems include a sample input fluid connection capable of being fluidically connected under pressure to the sample loading inlet on the micropurification card; an elution input fluid connection capable of being fluidically connected under pressure to a sample loading inlet to the elution inlet on the micropurification card. A card holder on the system is capable of holding the micropurification card in position to receive said sample input fluid and elution input fluid connections. Suitable card holders include a heater capable of heating a lysing region on the micropurification card to at least about 90° C.; and a thermal controller capable of heating a molecule capture region on the micropurification card to above about 40° C. and cooling the molecule capture region to below about 30° C. The system also includes a positionable fluid collection holder capable of receiving an elutant fluid comprising the molecules emanating from said elution tip. The systems of the present invention typically include one or more thermal controllers capable of heating a molecule capture region on the micropurification card to at least about 95° C. and cooling the molecule capture region to about −20° C. Suitable systems also include one or more card holders having a slot for receiving one or more micropurification cards.

Methods of collecting molecules using a card-based sample preparation system are also provided. These methods include fluidically communicating a sample comprising cells and a first buffer solution under pressure from a sample loading inlet to a lysing region on a micropurification card; heating the sample in the lysing region to a temperature in the range of from about 100° C. to about 150° C. at one or more pressures greater than ambient pressure to lyse the cells to give rise to lysed cell fragments and molecules; filtering the molecules from the lysed cell fragments at a temperature greater than about 90° C.; capturing at least a portion of the filtered molecules using a molecular capture material or device; eluting at least a portion of the captured molecules using a second buffer solution through an elution tip, the second buffer solution being the same or different than the first buffer solution; and collecting at least a portion of the eluted molecules and second buffer solution in a positionable fluid collection holder.

There are also provided methods for collecting molecules using a card-based sample preparation system. These methods include fluidically communicating a sample under pressure from a sample loading inlet to a heating region on a micropurification card. The sample is heated in the heater region to a temperature in the range of from about 100° C. to about 150° C. at one or more pressures greater than ambient pressure to breakdown at least a portion of the sample. The broken down sample fragments give rise to molecules, which are then filtered at a temperature greater than about 90° C. The method further includes the steps of capturing at least a portion of the filtered molecules using a molecular capture material or device; eluting at least a portion of the captured molecules through an elution tip; and collecting at least a portion of the eluted molecules in a positionable fluid collection holder.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 illustrates an embodiment of a micropurification card of the present invention;

FIG. 2 illustrates an embodiment of a perforated cap that can be used in the present invention;

FIG. 3 illustrates an embodiment of a molecular capture region and elution tip portions of a micropurification card of the present invention;

FIG. 4 illustrates an embodiment of a system for manipulating collection vials for use with a micropurification card of the present invention;

FIGS. 5A and 5B illustrates the loading of a micropurification card in a sample holder on the system of an embodiment of the present invention;

FIG. 6A-6D illustrates various views of a micropurification card of the present invention;

FIG. 7 is a close-up of section H-H in FIG. 6B to illustrate how fluids flow in an embodiment of a micropurification card of the present invention;

FIG. 8 is a close-up of section J-J in FIG. 6C to illustrate how fluids flow in an embodiment of a micropurification card of the present invention;

FIG. 9 illustrates how fluids flow in an embodiment of a micropurification card of the present invention;

FIG. 10 illustrates a cross-sectional perspective view of an embodiment of a micropurification card of the present invention;

FIG. 11 illustrates an embodiment of molecular capture region cartridge of the present invention;

FIGS. 12A-B illustrates an embodiment of molecular capture region cartridge of the present invention including an microarray;

FIG. 13 illustrates an exploded perspective view embodiment of a micropurification card of the present invention including a molecular capture region cartridge;

FIG. 14 illustrates an exploded perspective view embodiment of a micropurification card of the present invention including a molecular capture region cartridge;

FIGS. 15A-B illustrates two views of an elution tip of a micropurification card of the present invention adjacent to a sample collection vial of a system of the present invention;

FIGS. 16A-D is a series of views illustrating how collection vials and waste vials are manipulated along loading rails and position change rails with respect to a micropurification card that is held by a system;

FIG. 17 illustrates a protocol for purifying mRNA of the present invention; and

FIG. 18 illustrates a protocol for purifying mRNA of the present invention.

FIG. 19 illustrates a variety of cell disruption and target extraction and methods and devices. The top panel describes and illustrates several breadboard prototype designs of lysing devices. The second panel depicts spore lysis and DNA extraction results using breadboard prototypes of lysing devices. The third panel depicts RNA stabilization and qPCR results. At the bottom is depicted a design for a system of the present invention (lower left panel), as well as designs of the micropurification card of the present invention. Depicted is the preparation of DNA from spores, RNA from bacteria, and mRNA from eukaryotic cells using a micropurification cards of the present invention, along with the systems and systems.

FIG. 20 illustrates Tentacle™ probe design and function.

FIG. 21 depicts results with Tentacle™ probes.

FIG. 22 illustrates external testing results using Tentacle™ probes.

FIG. 23 illustrates a detection system design and fabrication.

FIG. 24a illustrates a process by which a micropurification card can be used in the user's perspective.

FIG. 24b illustrates a pathway that is used within the MCP instrument to perform the on-card sample preparation.

FIG. 24c illustrates a micropurification card (MCP) cap, complete with cooling channel, lysing region, as well as inlet and outlet ports for performing sample preparation.

FIG. 25 illustrates the arrangement used to mate a MCP to heaters and fluidic controls that operate a MCP.

FIG. 26 illustrates fluidic mating of a MCP to a manifold located inside a MCP workstation.

FIG. 27 depicts results of mRNA purification using the MCP and a suitable workstation .

FIG. 28 depicts results of total RNA purification using an MCP system.

FIG. 29 depicts an assembled MCP workstation that can accommodate eight MCPs.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

The micropurification cards provided herein comprise a plurality of fluidic components capable of extracting molecules from a sample. The plurality of fluidic components of the micropurification cards are substantially oriented in a plane, the plurality of fluidic components comprising: a sample loading inlet, an elution inlet, a lysing region capable of being heated to at least about 90° C. and pressurized to at least about 10 psi greater than the ambient atmospheric pressure to provide a lysed sample. They also include a filter capable of filtering molecules from the lysed sample, a molecule capture region capable of being heated to at least about 40° C., and an elution tip. The sample loading inlet is in fluidic communication with the lysing region, the lysing region being in fluidic communication with the filter, the filter being capable of fluidically communicating one or more molecules to the molecule capture region, and the molecule capture region being in fluidic communication with both the elution inlet and the elution tip. Optionally, one or more fluidic valves or channels can be fluidically positioned between any two or more of the fluidic components. For example, channels may be strategically positioned between the sample inlet and the lysing region to aid in keeping these components thermally isolated. One or more fluidic valves or channels can also be included for the purposes of regulating pressure in different parts of the micropurification cards. For example to build the back pressure across the filter, a narrow channel or valve can be placed between the filter and the capture material. Back pressure can also be created by the capture material.

The micropurification cards can be used with a variety of samples including the lysing of cells. In this instance, the lysing of cells can be effected using high temperatures and pressures. Depending on the additives in the lysis buffer most or all of the lysis quickly occurs occur. Suitable micropurification cards can include a region that combine both lysing and filtering of the cellular and molecular components. Occasionally, cells are able to lyse prior to being transmitted to the lysing region, this is pre-lysis. In the case of pre-lysis, the filter/lysis region is cleans the sample of cell walls, dirt and other detritus that could clog the molecular capture region. The heat in the lysis region is also important in denaturing nucleic acids before the capture region.

As used herein the term “cells” also includes viruses, protozoa, algae, and other single celled organisms and parasites, as well as plant cells and animal cells, including human cells. Accordingly, samples can be naturally derived, synthetically derived, or both naturally derived and synthetically derived. Naturally derived samples include at least one prokaryotic cell, at least one eukaryotic cell, at least one virus, at least one prion, at least one naturally derived molecule, or any combination thereof. For example, the naturally derived molecule can include a nucleic acid, an amino acid, a carbohydrate, a salt, a polysaccharide, or any combination thereof. Suitable prokaryotic cells include a bacteria, an algae, or any combination thereof. Suitable eukaryotic cells include a plant cell, an animal cell, or any combination thereof.

The micropurification cards can also be used for testing synthetically derived samples. Suitable synthetically derived samples include at least one of an industrial chemical, a drug molecule, a genetically modified organism, a synthetic nucleic acid, a synthetic amino acid, a synthetic carbohydrate, or any combination thereof. For example, the testing of industrial chemicals in groundwater is important for ensuring the safety of drinking water. Drug molecules can be tested for use in law enforcement applications, as well as quality control applications for pharmaceutical manufacture. Genetically modified organisms and cells, such as genetically modified plants (e.g., such as for use in food or feed), animals, bacteria, viruses, protozoa, and the like and bioagents, or any combination thereof, can also be tested. A number of other applications are readily envisioned by the art skilled person. Suitably, the naturally derived sample includes at least one plant cell, at least one animal cell, at least one human cell, at least one virus, at least one single cell organism, at least one prion, or any combination thereof.

The handling of micropurification cards in the field makes it desirable to be able to load the cards with a suitable sample, and seal it with a cap to avoid spillage and avoid cross-contamination of samples during testing. Suitable caps are capable of being sealed to the sample loading inlet, and are desirably capable of allowing fluid flow therethrough when subjected to a pressure differential, and the sample cap capable of preventing liquid flow therethrough when not subject to a pressure differential. Suitable sample caps comprise one or more pores each having a diameter of less than about 2 mm, and typically greater than about 0.1 mm. The cap can be used to seal the sample loading inlet. Suitable sample loading and inlets are capable of receiving a biological fluid sample, a tissue sample, a waste product, and environmental sample or any combination thereof.

The micropurification cards of the present invention have at least two of the fluidic components composed of a plastic, a metal, a ceramic, a glass, or any combination thereof. For the sake of efficiency and ease of manufacture, in some embodiments at least two, or even three or even four of the fluidic components are capable of being molded simultaneously from the same material. For example, at least two of the fluidic components can be injection molded simultaneously from a polymeric material. A suitable polymeric material comprises a cyclic olefin co-polymer, polyolefin, a polyacrylic, a polystyrene, a polycarbonate, a polyimide, a polyacrylonitrile, a polyester, a polyarylamide, a polyamide, a polyetherketone, a polyvinyl halide, or any copolymer or combination thereof. Suitable polyolefins comprise a polypropylene, a polyethylene, a cyclic polyolefin, or any combination thereof. Suitable cyclic polyolefins comprise a, Topas™ (COC), Zeonor™ (COP) polymer, a hydrogenated polystyrene, a polyvinylcyclohexane, or any combination thereof.

The micropurification cards can include a variety of fluidic structures supported on a card type material in a planar orientation. Two or more of the fluidic components of the micropurification card can be structurally oriented using a card-type material oriented parallel to the plane of the two or more of the fluidic components. Additional support ribs and or posts are capable of supporting the planar orientation of at least a portion of the fluidic components. The dimensions of the cards can range from several centimeters to tens of centimeters in height and breadth. Accordingly suitable support ribs or posts would typically have dimensions on the order of about several tenths of a millimeter to a centimeter or two. For example, support ribs or posts can be about 2 cm in height, and in the range of about 0.1 mm to 0.3 mm high, and about 0.3 mm wide. Support ribs or posts can be oriented in line with the direction of the fluid flow from sample to elution. The sample loading inlet can be further structurally supported to at least one of the other fluidic components using one or more of the support structure.

The lysing region is fluidically connected to both the sample inlet and the filter. The lysing region of the micropurification card can be provided by enclosing any region containing a filter using a filter cap oriented opposite to the filter. In certain embodiments, the filter cap and filter are oriented substantially parallel to the plane corresponding to the direction of insertion of the micropurification card in to a suitable system for providing fluids, temperature control, and sample recovery. At least a portion of each of the filter cap and the filter can be sealably affixed to one or more projections normal to the plane of the micropurification card. Suitable projections normal to the plane of the micropurification card can be in the shape of rings, squares, or other polygons. In certain embodiments, the filter can be supported by one or more help aid filtration of the sample, for example by ensuring the filter remains flat under an applied pressure differential. Such projections can be oriented normal to the plane of the micropurification card.

Suitable filters include a membrane filter, a packed particle bed, a frit, a cellulose material, a fibrous materials, or any combination thereof. Suitable filters also include packed beds of beats, frits with a porous structure for examples stainless steel frits. Cellulose and fibrous materials can also be suitably used in filters. Membrane filters are particularly useful as they enable wide surface area filtration with little dead volume. Suitable membrane filters can be composed of a polymer, a metal, a ceramic, a glass, or any combination thereof. Polymeric filters, such as PTFE and other fluoropolymers, are particularly desirable. Accordingly, the polymer may include a halogenated polymer, a polyolefin, a polyester, a polyamide, a cellulose, a polycarbonate, or any combination thereof. Suitable membrane filters are supported on a porous polymer substrate. The porous polymer substrate of a membrane filter can be sealably fixed to one or more sealing structures emanating normal to the plane of the micropurification card.

Suitable membrane filters are characterized has having a nominal pore size of less than about 5 microns, and in some embodiments have a nominal pore size in the range of from about 0.02 μm to 2 μm, more typically a nominal pore size in the range of from about 0.2 μm to 1.0 μm. Suitable filters are characterized as having a filtration area in the range of from about 50 square mm to about 5000 square mm, or even having a filtration area in the range of from about 100 square mm to about 600 square mm. Accordingly, the filter is of sufficient area to be able to filter at least about 100,000 lysed cells before clogging, and often the filter is of sufficient area to be able to handle up to about 10,000,000 cells before clogging. In some embodiments, the filter surface adjacent to the lysing region is characterized as being functionalized for the selective adsorption of biomolecules. This can be useful, for example, in minimizing the amount of biomolecules that enter the capture region. Suitable filter surface functionalization includes a silane reduction, a plasma treatment, an epoxy-amine, a hydrazine, an aldehyde, a polysine, UV cross linking, radical activation, thiol linking, a succinimdyl ester, or any combination thereof.

The filter cap is provided in certain embodiments to provide a lysing a region, or chamber, that is fluidically sealed to the card type material. This enables suitable molding of the materials for providing many of the fluidic components in a card type geometry, while permitting the bonding of a suitable filter membrane, followed by a ceiling of the lysing region with a suitable filter. The filter can be bonded using any of the variety of methods, including without limitation, gluing, ultra-sonically bonding, screw threading, pressure clamping, infra-red assembly method and the like. The filter cap (filter cap) can be composed of a material of sufficient thermal conductivity and thinness, whereupon contact with an external heater having a contact temperature of less than about 140° C., gives rise to the fluid within the lysing region being capable of reaching a temperature greater than about 100° C. in less than about three minutes.

The sample preparation can have a sample loading inlet that is vial-shaped, tube-shaped, prism-shaped, sphere-shaped, square shaped, oval-shaped, or any combination thereof. The sample loading inlet and the lysing region are in fluidic communication via one or more fluidic channels. Suitable fluidic channels can be used to connect, for example loading inlet to the lysing region, or the lysing region to the filter, from the filter to the capture region, or even from the elution inlet to the capture region, and the like.

A suitable sample loading inlet allows placement of a sample, such as a liquid or fluid comprising cells, tissues or blood or other environmental matter, into the card. The sample loading inlet is characterized as having a volume in the range of from about 0.1 ml to about 5 ml, or even having a volume in the range of from about 0.2 ml to about 3 ml. In certain embodiments the sample loading inlet is flexibly connected to a suitable sample cap.

The micropurification card of the present invention also includes an elution tip that is characterized as being tapered to an opening smaller in size compared to a fluidic connection with the molecular capture region. As the filter to and captured molecules that form the product prepared by the micropurification card exits the elution tip, it is desirable to minimize the amount of matter (i.e., product) that is caught up in the dead volume of the elution tip. In this regard, a suitable elution tip is characterized as having a volume of less than about 75 microliters. Suitable elution tips can even have volumes as small as about 0.05 microliters, which can be provided using a suitable pipette tip. Suitable elution tips are characterized as having a volume of less than about 60 microliters, or even having a volume of less than about 1 microliters. Suitable elution tips extend from a portion of the micropurification card and is capable of flowing molecules into an external sample collection vial. Elutions of low volume are achived by pre-heating the capture material, and then precisely controlling the amount and rate of liquid that is pumped through the capture region. In this way elution volume as low as 1.0 microliters can be achieved.

The lysing region of the micropurification cards of the present invention are capable of being heated to at least about 120° C. and pressurized up to at least about 80 psi. These properties are provided using materials of sufficient strength and thermal durability to be able to withstand elevated temperatures and pressures. As an example, injected molded plastics, such as high temperature polypropylene, polyolefins, and polycarbonates, can withstand such elevated temperatures and pressures. Additionally, plastics that can not withstand high temperatures for long periods of time can be used at higher than rated temperatures for short periods of time. In other embodiments, lower temperatures and pressures can be used as well. For example the lysing regions can be heated to at least about 95° C. and pressurized to at least about 10 psi greater than atmospheric pressures. Higher temperatures and pressures tend to be more desirable, and in other preferred embodiments, the lysing region is capable of being heated to at least about 150° C. and pressurized up to at least about 100 psi, or even capable of being heated to at least about 200° C. and pressurized up to at least about 350 psi. A variety of materials can be used at these elevated temperatures and pressures. For example, metals, ceramics, composite materials, and engineering thermoplastics can all be used.

The lysing region typically does not include any separate heating device built into the card, although it may. Accordingly, a suitable system will have a heater built into it, and the lysing region is positioned proximally adjacent to an external heater. For example, an external electric heater can be in direct thermal contact with the filter cap, which in turn heats the sample within the heated region. When cells are present in the heated region, the heated region can be used as a lysing region for lysing the cells under heat and pressure.

The elution inlet is capable of being fluidically connected to a fluid source exterior to the micropurification card. A suitable fluid source is provided by a system that is designed to fluidically connect and to heat the micropurification card. Suitable fluids that enter the elution inlet include, for example, buffers and other aqueous solutions that are capable of washing molecules away from the molecule capture region. Suitable elution fluids are described further herein.

The micropurification card includes one or more molecule capture regions for capturing molecules filtered away from the sample. In certain embodiments, the molecules are biomolecules, for example, nucleic acids and amino acids. The conformation of nucleic acid and amino acids tends to be temperature dependent, which can be used to advantage in capturing and releasing these types of molecules. For example, polynucleic acids are capable of hybridizing at temperatures below about 90° C. Accordingly, a molecular capture region composed of polynucleic acid strands can be used to capture the corresponding nucleic acid sequence. Release and elution of the captured molecules can be effected by heating the molecular capture regions to at least about 95° C. while flowing a buffer through the molecular capture regions and out through the elution tip. The release of purified nucleic acid molecules can be achieved at lower temperatures as well and is primarily controlled by the melting temperature of the DNA or RNA hybrid. Biomolecules typically become damaged above about 150° C. The molecular capture regions can be suitably heated using a heating block, heating cartridge, heat tape, and the like, or even a thermoelectric cooler mounted in a suitable system for receiving the micropurification card. In addition, it is also desirable to be able to cool the molecular capture region to temperatures at least below about 15° C., or at least below about 4° C., or at least below about −10° C., or even capable of being cooled to about −20° C. Temperatures below about 0° C. can be implemented, for example, by use of a suitable alcohol or anti-freeze, such as ethanol or propylene glycol, in the fluid entering the elution inlet. Various buffers can provide reduce the freezing points to below about −20° C. A thermoelectric or peltier cooler can be used to achieve these low temperatures.

The molecule capture regions can comprise an irremovable region integral to the micropurification card, a removable cartridge, or any combination thereof. For example, and a removable region integral to the micropurification card can be provided by an injection molding process of a substantial portion of the cartridge. Alternatively, a separate cartridge can be fabricated, filled with a suitable capture material or capture device, and attached to a fluidic port on the cartridge. Suitable molecule capture regions comprise a capture material or capture device capable of selectively capturing one or more types of molecules that are capable of being filtered by the filter. For example, the capture material can include a porous material, a packed bed material, a gel, metal frit, a capture material, cellulose, fiber membrane, any material capable of being functionalized or modified to bind with molecules of interest, glass, silicon, ceramic, polymer or any combination thereof. A suitable porous material comprises a porous polymer monolith. A suitable capture material can be functionalized with a nucleic acid, an amino acid, a carbon chain, a cation, an anion, a peptide, or any combination thereof. Nucleic acids that can be included in the capture region include, without limitation, a full length gene, a random DNA or RNA sequence, an aptamer, DNA LNA, PNA, RNA, a sequence specific oligo nucleotide, an allelic repeat, or any combination thereof.

The capture device can also include a microarray. The microarray cartridge can be made is two parts (two halves). The first half can include an open channel in the range of from about 200 microns to about 2 mm in width, and to which a porous substrate could be deposited and cross-linked and attached to the channel wall. The second part can be a solid half round (a lens essentially) that can be bonded to the channel. To accept the lens, the cartridge basement serial (i.e., card) can be stamped to accept the lens. In turn, the lens can be solvent bonded or UV epoxy bonded to the cartridge containing the microarray. Suitable plastic lenses are readily fabricated using a suitable acrylic-, polycarbonate-, or polystyrene-type resin. Alternatively a three wafer system could be used to prepare a microarray in the molecular capture cartridge. One wafer can have porous regions etched into it. This wafer can be bonded to the base wafer which contains the two via holes. The two wafers can then be spotted using either a robot or photolithography, such as digital light projection set ups. Once probe deposition is complete, the open face channel can then be sealed using this “lensed” top wafer. Alternatively, a molecular capture cartridge composed of a microarray device can be provided by alternatively packing of the cartridge with varying capture materials.

Micropurification cards can also include an identification tag. Suitable identification tags include an optically scannable code, magnetic strips, and electromagnetically readable signal, or any combination thereof. For example, the identification tag can include a barcode or an radio frequency identification (“RFID”) chip. A barcode reader can be used on the card and system, so that process conditions of the sample can be tracked along with the card. Barcodes can also be placed on the card along with a duplicate that can be attached to both or one of the elution vials.

It is desirable to limit the cross talk between the filter and elution region. Cross-talk (i.e., contamination) can be minimized by incorporating a suitable valve among the fluid components on the card. This can include a single use valve, which could alter the card, i.e., by heat sealing, deforming the channel, using a single direction valve, and the like. As described above, a small diameter stand-off channel can be used to limit cross talk between the regions.

Disposable micropurification cards are also enabled using injection molding processes to fabricate a substantial portion of the card and fluidic components. For example, cards can be injection molded to include a plurality of fluidic components capable of extracting molecules from a sample, the plurality of fluidic components comprising a sample loading inlet capable of being in fluidic communication with a lysing region, the lysing region being in fluidic communication with a filter, the filter being capable of fluidically communicating one or more molecules to a molecule capture region, and the molecular capture region being in fluidic communication with an elution inlet and an elution tip. These disposable micropurification cards can also include a sample cap. Suitable sample caps are capable of being sealed to the sample loading inlet, the sample cap capable of allowing fluid flow therethrough when subjected to a pressure differential, and the sample cap capable of preventing liquid flow therethrough when not subject to a pressure differential. In addition, a portion of each of the fluidic components can be provided by the injection-molded card. The disposable micropurification cards are suitably used for obtaining molecules, such as nucleic acids like DNA, from cells.

Systems suitable for preparing samples in one or more micropurification cards at elevated temperatures and pressures are also provided. Systems of the present invention include a sample input fluid connection capable of being fluidically connected under pressure to a sample loading inlet on the micropurification card; an elution input fluid connection capable of being fluidically connected under pressure to a sample loading inlet to an elution inlet on the micropurification card; as well as a card holder capable of positionally holding the micropurification card to receive the sample input fluid and elution input fluid connections. The card holders may also include a slot for receiving the micropurification card.

In addition, the card holder includes a heater capable of heating a lysing region on the micropurification card to at least about 90° C. and a thermal controller capable of heating a molecule capture region on the micropurification card to above about 40° C. and cooling the molecule capture region to below about 30° C. The system also includes a positionable fluid collection holder capable of alternately positioning two or more collection fluid receptacles for receiving fluid exiting an elution tip on the micropurification card.

The system can be used for controlling the heating and cooling of the various fluidic components on the micropurification card, as well as controlling the pressures of the fluids within the fluidic structures of the card. Accordingly, fluids are able to both enter and exit the micropurification card. When exiting, the fluids can be collected in one or more receptacles. For example, one of the collection fluid receptacles can be a waste fluid collection receptacle and another can be an elutant fluid receptacle. Here, the positionable fluid collection holder can be capable of being alternately slidably positioned to receive a waste fluid exiting from said elution tip into the waste fluid receptacle, or to receive an elutant fluid emanating from said elution tip into the elutant fluid receptacle. Many other variations of collecting fluids by manipulating the positions of collection vials with respect to the elution tip of the micropurification card are envisioned.

The system can include one or more thermal controllers that are capable of heating the molecule capture region on the micropurification card to at least about 95° C., and typically higher. Cooling devices, such as thermoelectric coolers can also be provided for cooling any one or more of the fluidic components, such as the molecule capture region, to temperatures as low as about −20° C. In other embodiments, the heater of the system is capable of heating a lysing region on the micropurification card to at least about 95° C., or at least about 100° C., or at least about 110° C., or at least about 120° C., or at least about 130° C., or at least about 140° C., or at least about 150° C.

In other embodiments the fluid connections of the system are capable of increasing the pressure inside the micropurification cards to at least about 10 psi, or at least about 20 psi, are at least about 40 psi, or at least about 80 psi, or at least about 120 psi, or even at least about 150 psi, or even at least about 200 psi, or even at least about 250 psi, or even at least about 300 psi, or even up to about 350 psi. High pressure tubing and coupling joints are readily available for such operation.

Additional sample card inventory components and systems can be included in the system. For example, the system may further include a scanner for reading an identification tag, such as a barcode or an RFID tag, as described hereinabove.

Systems are also provided that are suitable for collecting molecules from samples using disposable micropurification cards at elevated temperatures and pressures. These systems include one or more disposable micropurification cards and a systems suitable for preparing samples in micropurification cards. In these systems, the micropurification cards include an injection-molded card comprising a plurality of fluidic components capable of extracting molecules from a sample comprising one or more cells, the plurality of fluidic components comprising a sample loading inlet capable of being in fluidic communication with a lysing region, the lysing region being in fluidic communication with a filter, the filter being capable of fluidically communicating one or more molecules to a molecule capture region, and the molecular capture region being in fluidic communication with an elution inlet and an elution tip. Suitable systems include a sample input fluid connection capable of being fluidically connected under pressure to the sample loading inlet on the micropurification card; an elution input fluid connection capable of being fluidically connected under pressure to a sample loading inlet to the elution inlet on the micropurification card. A card holder on the system is capable of holding the micropurification card in position to receive said sample input fluid and elution input fluid connections. Suitable card holders include a heater capable of heating a lysing region on the micropurification card to at least about 90° C.; and a thermal controller capable of heating a molecule capture region on the micropurification card to above about 40° C. and cooling the molecule capture region to below about 30° C. The system also includes a positionable fluid collection holder capable of receiving an elutant fluid comprising the molecules emanating from said elution tip. The systems of the present invention typically include one or more thermal controllers capable of heating a molecule capture region on the micropurification card to at least about 95° C. and cooling the molecule capture region to about −20° C. Suitable systems also include one or more card holders having a slot for receiving one or more micropurification cards.

Methods of collecting molecules using a card-based sample preparation system are also provided. These methods include fluidically communicating a sample comprising cells and a first buffer solution under pressure from a sample loading inlet to a lysing region on a micropurification card; heating the sample in the lysing region to a temperature in the range of from about 100° C. to about 150° C. at one or more pressures greater than ambient pressure to lyse the cells to give rise to lysed cell fragments and molecules; filtering the molecules from the lysed cell fragments at a temperature greater than about 90° C.; capturing at least a portion of the filtered molecules using a molecular capture material or device; eluting at least a portion of the captured molecules using a second buffer solution through an elution tip, the second buffer solution being the same or different than the first buffer solution; and collecting at least a portion of the eluted molecules and second buffer solution in a positionable fluid collection holder.

The methods of the present invention may further include the step of inserting the micropurification card into a system suitable for preparing samples in a micropurification card. For example, a micropurification cards filled first with a biological sample and capped. The card is then inserted through the slot of a card holder, which controls the temperature of various fluid components on the card, as well as maintains fluidic connections and pressures within the card. The fluid connections provided by the system typically are capable of providing buffer solutions suitable for manipulating samples such as biological samples including cells. For example, one or both of the buffer solutions may should comprise a DNase, an RNAse, an inhibitor, a salt, a buffer, a detergent, water, an organic solvent, an acid, a base, or any combination thereof.

There are also provided methods for collecting molecules using a card-based sample preparation system. These methods include fluidically communicating a sample under pressure from a sample loading inlet to a heating region on a micropurification card. The sample is heated in the heater region to a temperature in the range of from about 100° C. to about 150° C. at one or more pressures greater than ambient pressure to breakdown at least a portion of the sample. The broken down sample fragments give rise to molecules, which are then filtered at a temperature greater than about 90° C. The method further includes the steps of capturing at least a portion of the filtered molecules using a molecular capture material or device; eluting at least a portion of the captured molecules through an elution tip; and collecting at least a portion of the eluted molecules in a positionable fluid collection holder. These methods can further include, in alternative embodiments, the step of inserting the micropurification card into a system suitable for preparing samples in a micropurification card.

Molecules can be collected from lysed cells using a card-based sample preparation system that does not necessarily require heating to lyse samples. For example, one method includes fluidically communicating a sample comprising cells and a first buffer solution under pressure from a sample loading inlet to a lysing region on a micropurification card; lysing the cells in the lysing region using a lysing agent, sonication, or both, at one or more pressures greater than ambient pressure to give rise to lysed cell fragments and molecules; filtering at least a portion of the molecules from the lysed cell fragments; capturing at least a portion of the filtered molecules using a molecular capture material or device; eluting at least a portion of the captured molecules using a second buffer solution through an elution tip, the second buffer solution being the same or different than the first buffer solution; and collecting at least a portion of the eluted molecules and second buffer solution in a positionable fluid collection holder. This method is especially useful for recovering molecules such as RNA, mRNA, or any combination thereof from eukaryotic cells. Suitable RNase inhibitors are present in the lysing region. More robust cells, such as bacterial spores, are suitably lysed at elevated temperatures, up to about 150° C., and typically in the range of from about 90° C. to about 150° C. In certain embodiments of the desirable to filter the molecules, for example RNA, at temperatures greater than about 90° C.

Various buffer solutions, such as lysing agents, may be included in the methods to help break down the sample fragments. For example, one or more buffer solutions comprise a DNase, an RNAse, an inhibitor, a salt, a buffer, a detergent, water, an organic solvent, an acid, a base, or any combination thereof.

In one embodiment, there is provided a system, denoted a MCP system for isolating nucleic acids from a biological sample. The MCP system flows biological cells dispersed in a stabilization buffer specific for genomic DNA, total RNA, or mRNA, from a sample vial integrated into a disposable MCP, to an integrated lysis region on the MCP. The cells are then lysed while simultaneously filtering and flowing the nucleic acids at about 130° C. within the lysis region to form a filtrate. The filtrate, which comprises nucleic acids, non-nucleic acid molecules from the cells, as well as stabilization buffer, then flows through an integrated serpentine cooling region on the MCP. The cooled filtrate then flows through a capture region located within a pipette tip attached to the card. The capture region contains different capture media depending on the type of nucleic acid that is captured as the filtrate flows past the capture medium. Glass fiber is used in the capture region for capturing genomic DNA or total RNA, and oligo-dT-linked cellulose is used in the capture region for capturing mRNA. The captured nucleic acids are then washed to remove impurities. A first wash uses an aqueous buffer comprising chaotropic salts, 80% ethanol, and water at about 20° C. A second wash uses 80/20 ethanol/water to remove buffer and salts at about 20° C. In a final step, the captured nucleic acids are released from the capture material to an external sample collection vial by eluting in RNase-free water at a temperature in the range of from about 65° C. to about 95° C.

### EXAMPLES AND ADDITIONAL ILLUSTRATIVE EMBODIMENTS

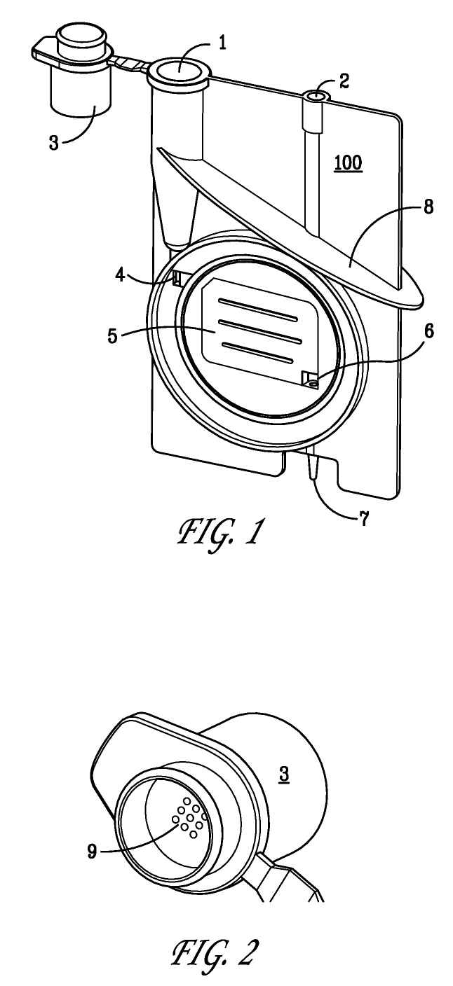

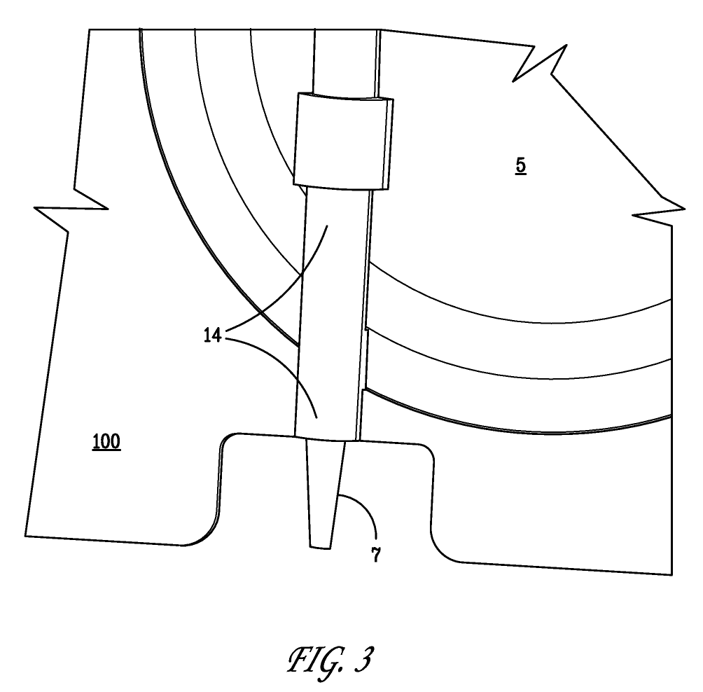

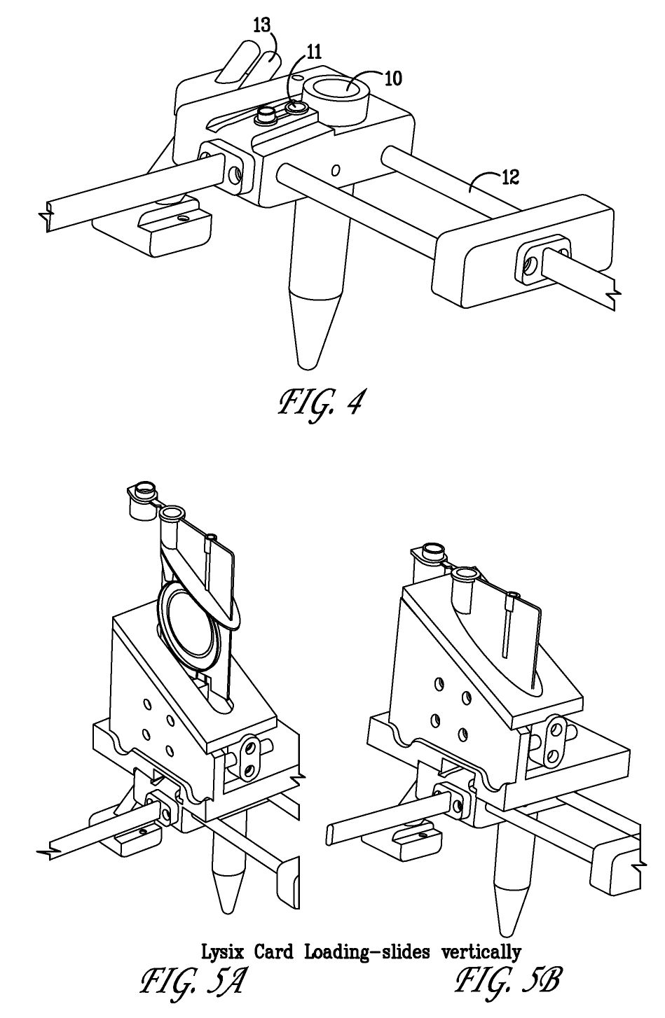

FIGS. 1-29 illustrate various examples and embodiments of the present invention. In these figures, the term “Lysix” or “Lysix™” can be interchanged with the term MCP or micropurification card. The following table lists the numerical references to the various components discussed in this section.

TABLE

| | |
|---|---|
| 1 | Sample inlet |
| 2 | Wash/Elute Buffer elution inlet |
| 3 | Sample Lid (cap) |
| 4 | Sample connection between sample inlet and lysing region |
| 5 | Filter/lysing Region |
| 6 | Outlet from lysing region |
| 7 | Elution Tip |
| 8 | Support Rib |
| 9 | Surface tension Perforations |
| 10 | Filtrate (waste) Collection Vial |
| 11 | Sample (molecule)Collection Vial |
| 12 | Loading Rails |
| 13 | Position Change Rails |
| 14 | Capture Material |
| 15 | Filter Cap |
| 16 | Filter |
| 17 | Supporting Rib |
| 18 | Vial Position Change Handle |
| 19 | Collection Vial Holder |
| 20 | Vial Loading Handle |
| 21 | Elution Cartridge |
| 22 | Elution Cartridge slot |
| 23 | Elution Cartridge capture region |
| 24 | Elution Cartridge tip |
| 25 | Thermoelectric cooler/heater |
| 26 | Capture region plug |
| 100 | Micropurification card |

### Example

### Processing Micropurification Cards (FIGS. 1-5)

Referring to FIGS. 1-5, here is described how samples are processed using exemplary micropurification cards of the present invention.

Sample process flow:
1) Sample is loaded onto the micropurification card 100. The on card vial (sample loading inlet 1) is modeled after standard lab vials. Sample is pipetted into card into sample at loading and let one. [sample loaded in 1]
2) Sample Lid is closed and perforations prevent spilling of sample. Perforations also limit crosstalk. [Cap at 3 and perforations at 9]
3) Card is inserted into the system (FIGS. 4, 5A and 5B). As the card is inserted it slides along rails and is locked into position. The heating element for the capture region is press fit against card. [Shown above “MCP loading” in FIG. 5B]
4) Fluidic connections made. [Done at 1 and 2]
5) Thermal heaters engaged. [Heater presses against 5]
6) Collection vial set to wash position [slides to top of 13].
7) Capture material pre-wetted with wash/blocking buffer [from connection at 2].
8) Thermal regions preheated. 95, and 40-50 degrees centigrade [at 5 and 14].
9) Lysis buffer pushes sample through filter/lysis region [through fluid connection at 1].
10) Selective trapping of molecules in capture material [at 14]
11) Wash/block buffer used to wash capture region with captured sample. This can use a cooled collection area [fluid flow from 2, cooling from thermoelectric cooler (TEC) at 14].
12) Change of collection vial from waste to collection [slide to bottom along 13].
13) Elution buffer introduced onto capture region [through fluid connection 2].
14) Capture material heated to release bound sample [fluid through 2 and heating at 14].
15) Elution buffer pumped to elute sample into new vial [released from 14].
16) Card removed and discarded. Waste can be processed to extract other biomolecules. Such as proteins or unbound nucleic acids.

### EXAMPLE

### Micropurification Card

An example of a micropurification card of the present invention can be a consumable about the size of a credit card. The sample is loaded, lysed, filtered, and trapped on the micropurification card. The card has 2 fluid inputs, 1 output, and 2 thermally controlled regions. These inputs and thermal regions are interfaced in the base system.

Manufacture. A suitable micropurification card is injection molded using polypropylene (PP). Polycarbonate (PC) cyclic olefin co-polymer or a cyclic olefin polymer can also be used and has a higher use temperature than polypropylene.

Fluid Connections. A sample vial (sample loading inlet) is incorporated into a sample card, the size and shape of the sample vial is similar to standard lab vials. Using the card along with the system reduces the number of user steps required to process a sample. The on-card sample vial fluid connection is made through the perforated cap. Unlike a typical sample vial which only seals the sample into the vial, the cap of the micropurification card has perforations which allow pressurized fluid flow. When the cap is sealed the perforations are small enough that fluid flow is limited by surface tension. When fluid connection is made to the top of the crown fluid flow through the cap is generated with pressure pumping. The advantage of this design is that it greatly reduces the chance of sample carry over. The perforations in the cap creates a barrier between the sample and the fluid connection. This can eliminate the need for cleaning of fluid connections between samples. Input fluid connection is made by a pressure fit at the top of the card. Experiments have shown that this type of fit can handle at least 100 psi, which is readily adapted to the buffer/wash elution inlet 2. As described above the vial cap 3 has a crown and perforations 9 to prevent sample to sample cross contamination.

Output fluid connections. Output fluid connection is created through an exit tip (elution tip 7). This is readily provided using injection molding. The dead volume inside the elution tip is desirably reduced as much as possible so that the extracted biomolecule is as concentrated as possible. The manufacture of the tip is comparable to a pipette tip. The dead volume of the elution tip in this example is about 1 ul.

Filter and lysing region. Filtering needs in preventing clogging of the various fluidic channels, for example for pressure restriction, and also helps to prevent clogging of the molecule capture region. One example lyses a cell containing sample and then filters the material before it gets to any size sensitive regions in the card.

The filtering capability can be determined by the surface area and pore size of the filters. As the surface area increases the capacity of the filter also increases. Also as the pore size increases the capacity also increases. A 1-inch 0.22 um filter can handle 2 million unlysed cells before clogging. Handling ˜1 million cells per sample equates to an approximate surface area of 500 mm̂2.

Without filtering all of the cells would probably not be lysed. The lysing of the cells in flow through only (without filtering) would depend on residence time at elevated temperature. This causes problems because the longer the sample is at elevated temperatures the more damage there is done to the biomolecules of interest. But if the sample flow rate is too high only a small fraction of cells will be lysed. In the current invention the lysis region has filtering capability as well. This provides many advantages in comparison to previous technology. As stated the lysis of a cell is partially dependant on time at temperature, by placing a filter region in the lysis area cells that have not lysed will be trapped and held at an elevated temperature until lysis occurs. But any biomolecules that are released from the cell can pass through the filter and are not subjected to higher temperatures for longer than necessary. This means more cells lysed, and less damage to the biomolecule of interest. This also means that any biomolecules that have been released prior to reaching the lysis region are free to pass quickly through the elevated temperature.

The filter removes any cell walls or membranes from the sample preventing them from clogging the capture region downstream.

The surface of the filter member and can be modified chemically. This can allow for more specific extraction of “garbage” biomolecules, which essentially gives rise to adding a precleaning feature.

Molecular Capture Region. Materials useful for the capture region in this example includes any material that can bind or extract a molecule. In one example, for purification that are based on precipitation of the analytes on a membrane this can be a native material, such as microcrystalline cellulose, or silica. Alternatively, for hybridization reaction, Oligo dT, etc. the capture material can be functionalized to accept aldehyde or glycidal, or amine chemistry to allow the covelent attachment of a capture oligonucleotide. Amines can be used with aptamers. The common material for this is silica since it is the base for microarray slides. Polymer materials having both endings attached can be used. Suitable polymer materials include using ethylene glycol dimethacrylate and glycidal(or aldehyde)methacrylate; when crosslinked the functional surfaces are exposed. Other materials with functional groups are latex, PTFE, poly propylene, poly carbonate, polystyrene, Polymethylmethacrylate (PMMA), polyvinyltoluene (PVT), styrene/butadiene (S/B) copolymer, styrene/vinyltoluene (S/VT) copolymer- plain (undyed), hydrophobic (sulfate surface groups). See http://www.bangslabs.com/products/bangs/guide.php.

The capture material can be a fixed matrix with an approximate 35% void fraction (ie 65% solid substrate). If the void fraction is too large interactions between the biomolecule of interest and the probe are not as likely. As the void fraction decreases the back pressure increases, and a very small void fraction can slow the ability to flow sample through the material.

The problem with capillaries is the manufacturability. The capillaries would work great and have extremely low dead volumes for elution of the sample, but they would be difficult to mass produce. The capture area needs to be tightly controlled to make sure the biomolecules are trapped and can be released. One of the problems with a capillary is in defining the region in which the material is created. The polymer material can not extend to the end of the capillary because the temperature control can not be run to the end of the capillary (this would interfere with eluting very small volumes. If the material is not heated during elution some of the sample would become bound to the material in the uncontrolled region. A second problem with capillaries is their fragility. Any impact or sharp edge could break the capillary and the card/sample would be lost.

The molecular capture region 23 can be created inside a channel of the micropurification card 100. The capture material is then injected or inserted into the open channel. In one configuration a first frit 26 is inserted down the buffer/wash channel. Next the capture material (e.g., functionalized silica beads with oligo dT or other specific nucleic acid sequence attached) is flowed/injected behind the frit. A second frit 26 is inserted behind the silica bead material. The frits are used to contain and create the capture region.

Temperature control regions. There are two separate temperature controlled regions in this example. Temperature control of these regions is needed for the lysis/denaturing and extraction of the biomolecules.

Lysis and denaturing. The lysing region is heated by a resistive heater mounted in the system (not shown), which includes a suitable temperature controller, which are commercially available.

The minimum temperature for lysis and denaturing is 90° C. The lower limit is dependant on the need to denature the nucleic acids before entering the capture material. Even if the sample is lysed before it is inserted on the card it can be heated for denaturing. The upper limit is determined by the card material, and the sample that is being processed. Injection grade PP has a high end temperature of ˜100-130° C. and Injection grade PC has a high end temperature of ˜150-160° C. limits. For more robust samples the lysis temperature will be increased to ensure more cells are broken open, and more labile cells will have lower temperatures to help maintain biomolecule integrity.

After the card is inserted into the base system the resistive heater is pressed into contact with the lysis region of the card. This region could also be controlled by a TEC, or other conceivable heaters. The specific reason for not using a TEC is that cooling will not be required in the region. Once lysis is complete the heater will be turned off and the region will cool through radiation. Air flow control of the heating/cooling regions can also be used.

A second thermal component of the lysis region is the denaturing of the sample prior to entering the capture region. This helps to achieve increased binding of the biomolecules. If the sample is not denatured there is a decreased chance that it will be open and receptive to hybridization in the capture region. The minimum temperature for denaturing is 90° C. There is a slight overlap of the lysis and capture thermal regions. This helps to prevent the sample from cooling before reaching the capture material.

The capture material thermal control region also is cooled after heating by using a TEC. Cooling is used for proper hybridization of the selected biomolecules. Also after hybridization the sample is cooled to prevent further chemical reactions or degradation.

Capture Material. Without being bound by any particular theory of operation, the temperature control of the capture material tends to control the specific extraction of biomolecules. Prior art has used surface energy interactions to trap all Nucleic Acids (NA's). In a high salt buffer, NA's preferentially bind to the silica charged surface. As the salt is removed from the buffer the NA's release and are ready for further processing. The problem with this method is that it collects all NA's not just the ones of interest. This process can also be improved by controlling the temperature, but the specificity is not there.

Other methods often used in the field utilize oligo dT attached to a fixed surface. The most common substrates are cellulose, and magnetic particles. This enables more specific hybridization, but the methods do not tightly control the temperature of the sample or substrate. It is the tight thermal control of the sample and substrate that allow for very specific extraction of mRNA's. The thermal properties of a fluid sample can be tightly controlled using a flow through environment. The thermal capacity of the fluid begins to reduce control as the volume increases.

Micropurification card System. This is the base that holds and processes the micropurification card. Most of the features of the system have been described hereinabove.

Collection vials. Two collection vials are used for full sample processing. The actuation of a loading tray allows the collection of discrete fluids in the same system. First is a waste vial that collects all of the unbound NA's and protein in a combination of lysis and wash buffer. It is possible that any biomolecules not extracted could be further processed. The use of a waste vial also contains any waste. The volume of this vial is anywhere from 5-15 mL. A 2 mL sample is estimated to generate ˜7 mL of waste fluid. (2 mL of sample 4 mL of lysis buffer, and 1 mL of wash/block buffer). The second vial is for capturing the concentrated biomolecule of interest. When the lysis and clean-up are complete the sample collection vial is brought against the edge of the elution tip. In this way a small volume ˜10 uL can be eluted from the card and captured in a vial.

User interface. The front end of the system is simple and easy to use. The cards are inserted in one direction. After sealing the fluid connections, the user actuates a lever/dial that locks the lysis heating region in place. A run button is pressed and the sample is processed cleaned and eluted.

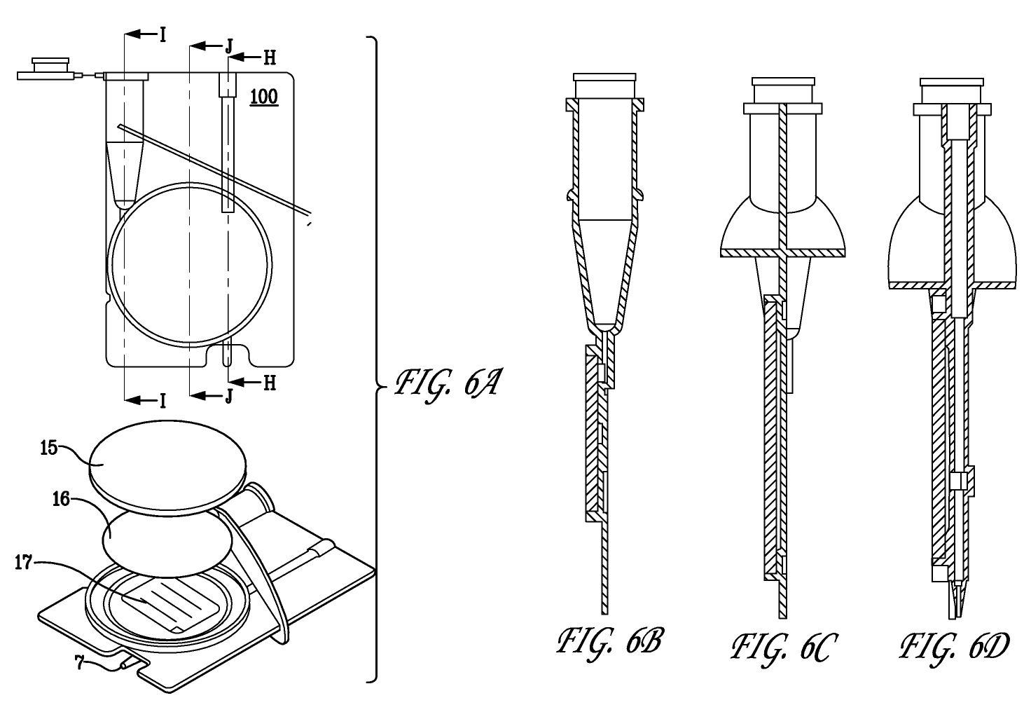

FIGS. 6A-6E. Overview of cross section areas. The view at bottom (6E) shows an exploded view of micropurification card 100 with filter 16 and filter cap 15. Cross-sections I-I, J-J, and H-H of the micropurification card 100 are also illustrated.

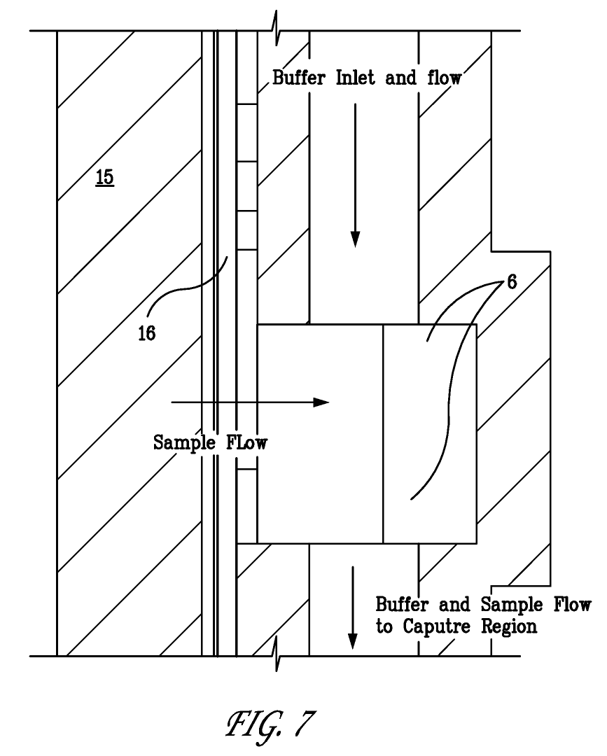

FIG. 7. Close-up of section H-H. This shows where the sample exits the filter and the fluid connection to the capture region. At this point there can still be some fluid flow across the filter (16). Most of the sample will have passed through the filter and will flow through the channels created by the supporting ribs. The fluid connection to the capture material is made at (6). This larger hollow is needed as a support for the injection molding. At (6) the elution and wash buffers are connected from (2) (not pictured).

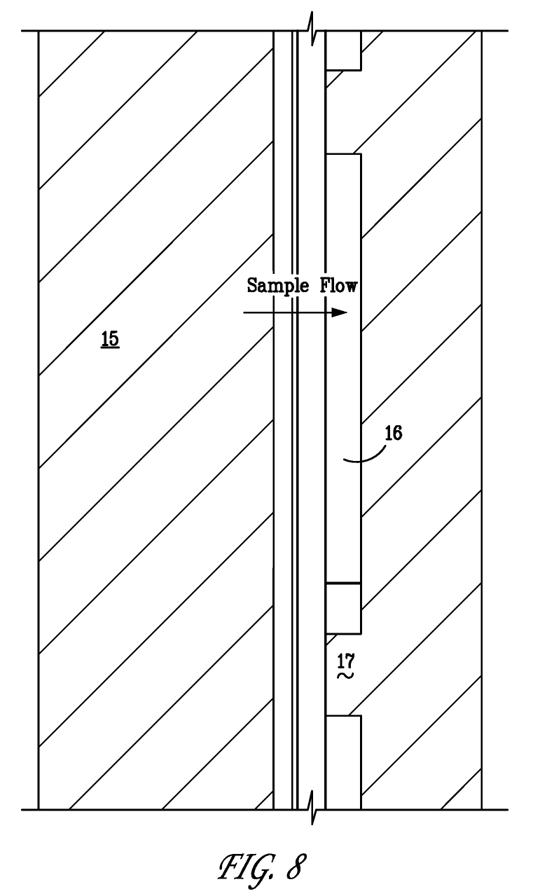

FIG. 8. Close up of section I-I. The sample is loaded in the sample vial (1). The end of the vial has fluid connection with the filter and heat region through (4). The filter cap (15) seals the filter in place (see next diagram). For injection molding (4) is made slightly larger to accept the molding pin that creates (1) and the channel to (4).

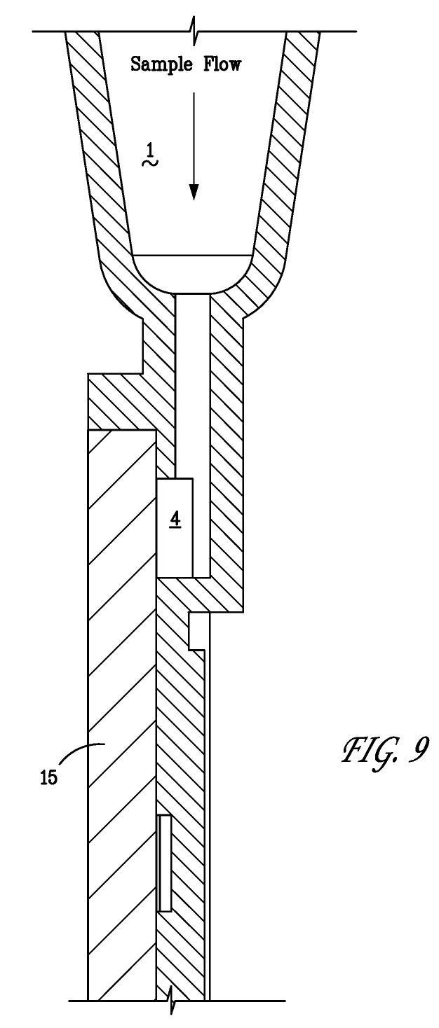

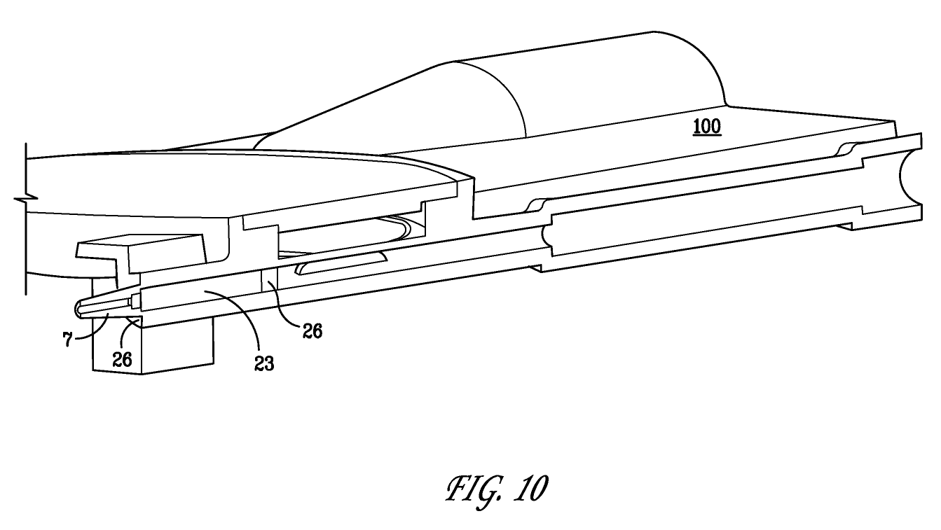

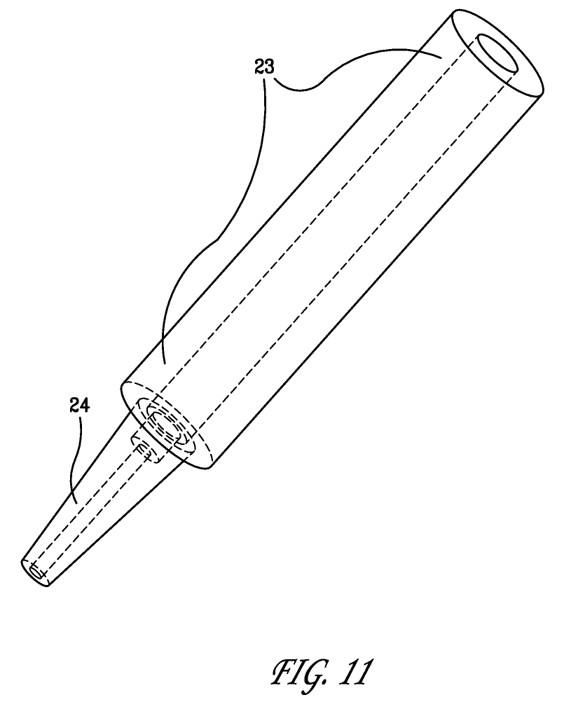

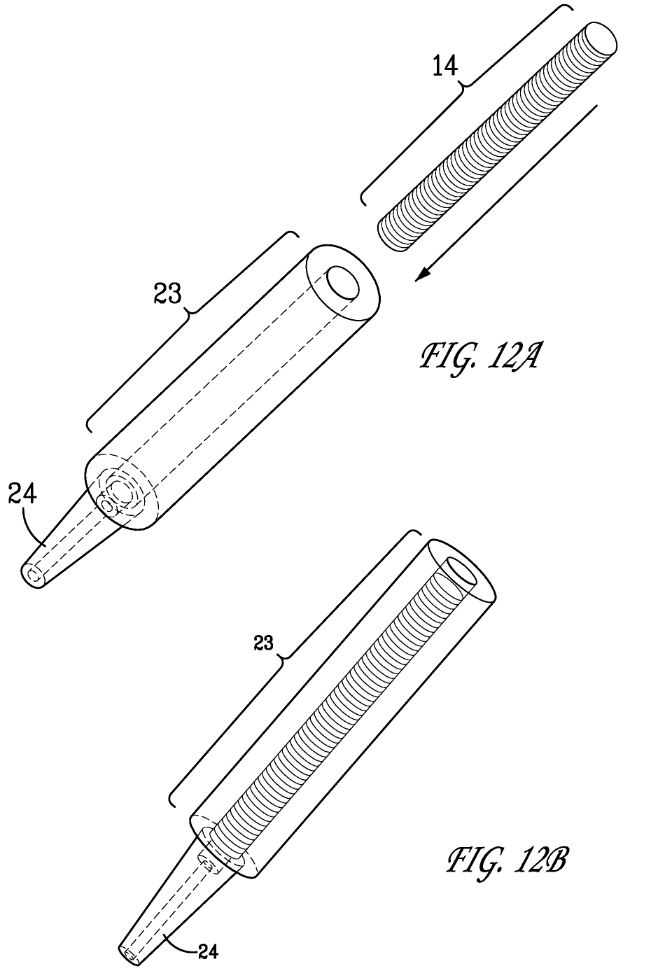

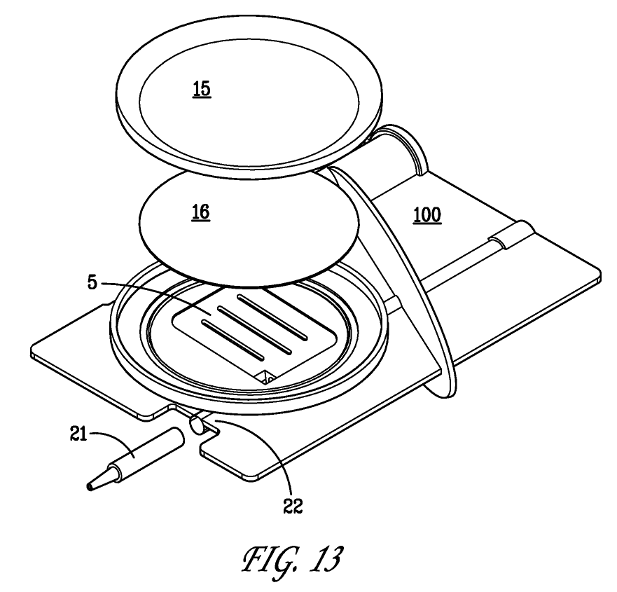

FIG. 9. Close-up of section J-J. Sample that has been introduced to the filter region through (4) flows across the filter (16). The filter is between 0.22 um and 0.45 um ideally, but the porosity could be increased to allow larger particles or decreased to trap smaller particles. The filter is held in place by ribs (17), which make sure that the filter does not collapse and prevent flow altogether.

FIG. 10. illustrates a cross-sectional perspective view of an embodiment of a micropurification card 100 of the present invention. The cross-sectional view is along the elution inlet, which is at the right hand side of the drawing. This view describes how a molecular capture region can be inserted into the micropurification card. First, an inert filter plug is packed into a first hole at 26. Subsequently, a suitable molecular capture material or device, such as a powder, is introduced using a suitable probe or hypodermic needle, for example, into the elution capture region 23. Subsequently, a second inert filter plug is packed and after the molecular capture region. This view also illustrates that the elution tip has a small void volume. Also depicted in this figure, is the licensing region positioned between a filter cap and a membrane filter. The membrane filter is shown being welded to the card.

FIG. 11. Elution Cartridge wireframe drawing. This drawing shows the interior dimension of the elution cartridge. The capture region (23) is contained within the cartridge and the elution tip (24) can be manufactured to reduce volumes significantly. Inside the capture region a porous material is packed, said material can be functionalized with a variety of chemistries for extraction of specific species. In certain embodiments the capture region is packed with layers of porous material so that a linear microarray is formed. The material of the elution cartridge varies, most often it is the same as the surrounding card, but in the case of a microarray it is specifically made of an optically transparent material.

FIGS. 12A and 12B: Packing of Elution Cartridge. The capture material (14) is stuffed/packed/flowed into the capture region of the elution cartridge (23). An alternative packing of the cartridge is crosslinking the material in place. In the above picture the capture material is depicted as a microarray, but all sections could have the same chemical treatment. Forming of the microarray capture material can be achieved by layering an array of flat materials on top of each other, and then coring a plug from the stack. Alternatively the capture material can be formed/inserted into the cartridge and later labeled via a mechanical spotter. In the embodiment as a cartridge the crosslinking or sol-gel material can be aspirated through the tip and affixed in place; this is specifically advantageous for loading multiple cartridges, for example, in a 96 or 384 well format.

The elution tip (24) is designed to limit the dead volume and direct the eluted sample into the collection vial. The collection material may need to be thermally controlled to release the molecule of interest. This is especially true for elution of Nucleic acids, and thermally releasing the NA's from the collection material. Elution of the sample can also be achieved via a buffer change, for example affinity for hybridization is decreased in low salt buffers.

The collection material and elution cartridge capture region, have been designed to reduce the dead volume of the capture molecules. With the capture material present the total dead volume is approximately 30 ul, and the tip has a dead volume of 10 ul.

FIG. 13. Micropurification card with Elution cartridge 21. This design makes the assembly more modular and more readily changed for future cartridges. The elution cartridge (21) is inserted into the elution cartridge slot (22), when fully inserted it looks the same as previous pictures of the card. This can be sealed in a variety of ways, thermal bonding at the end, UV gluing, pressure fit sealing.

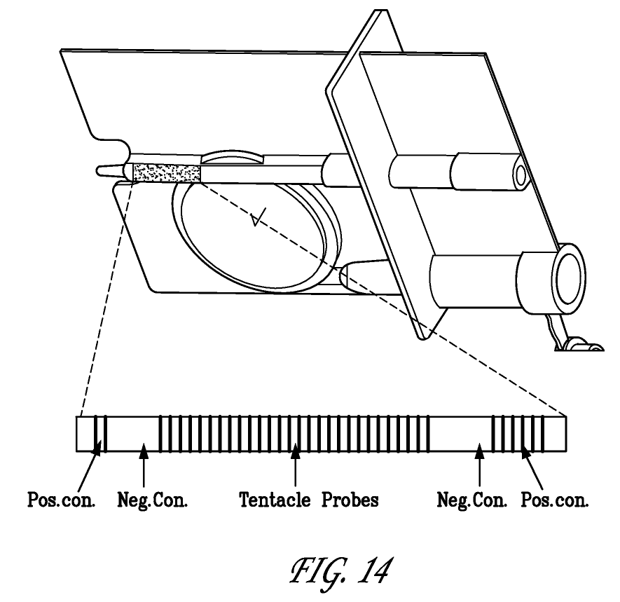

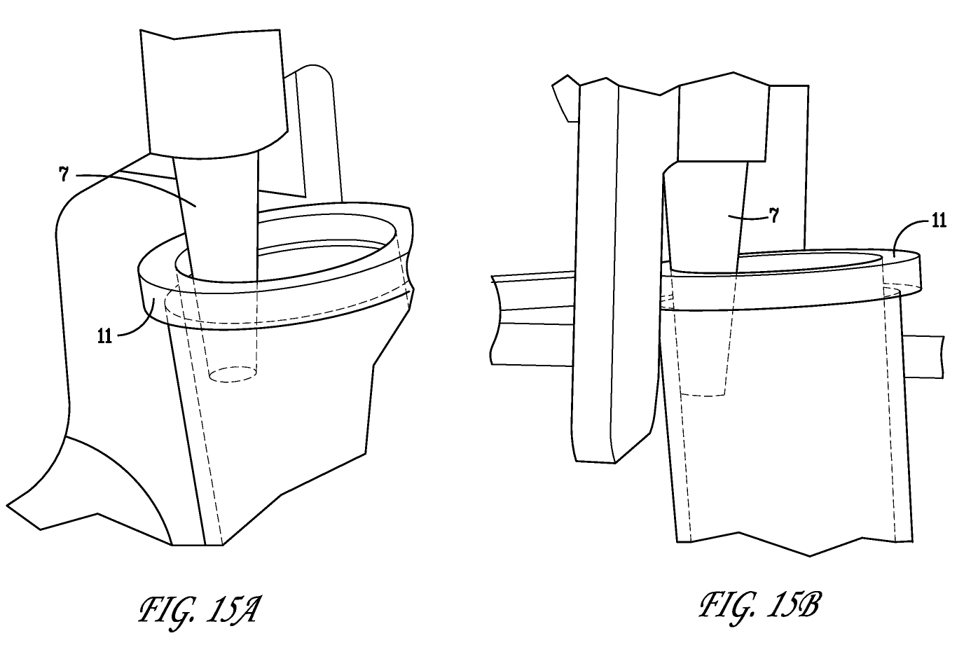

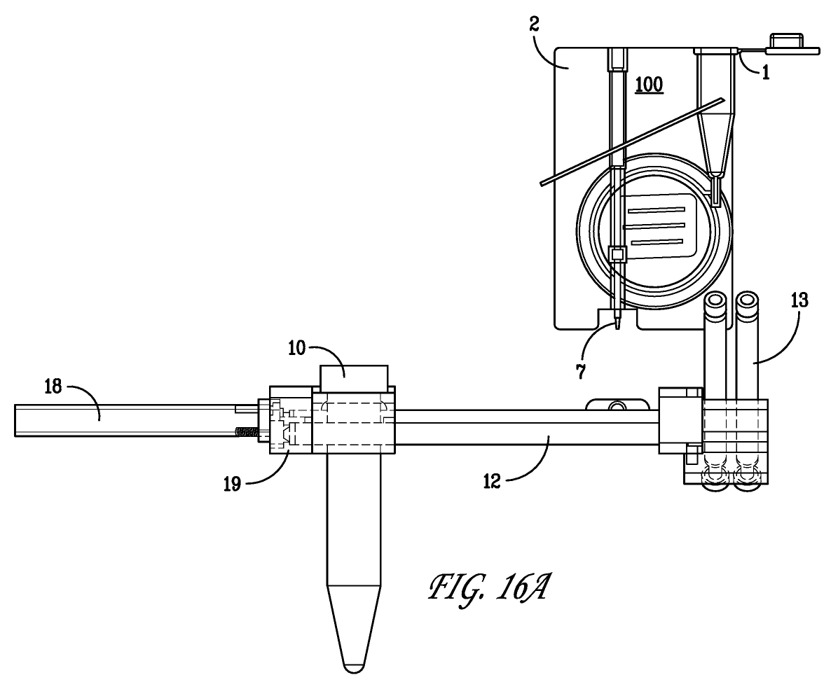

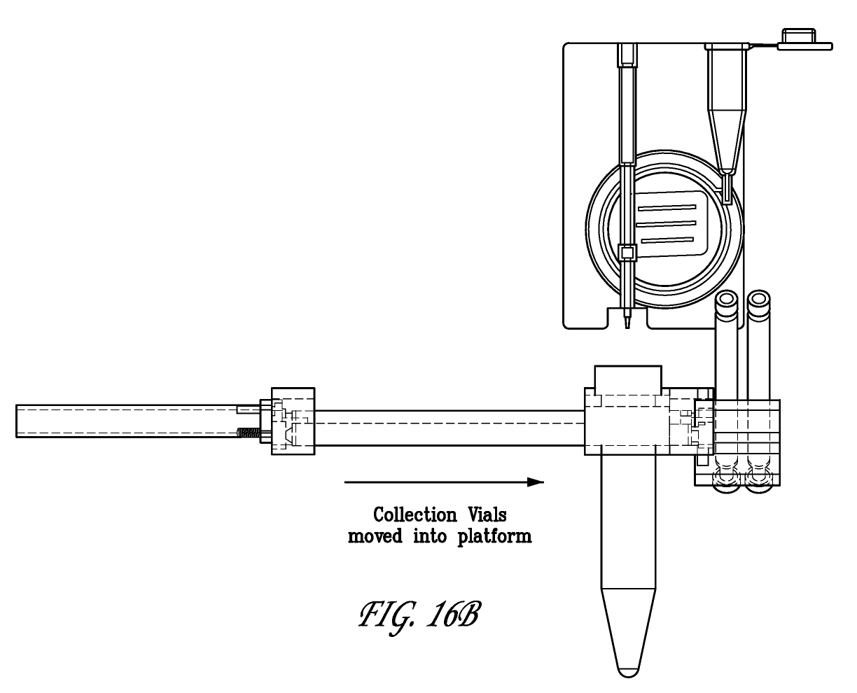

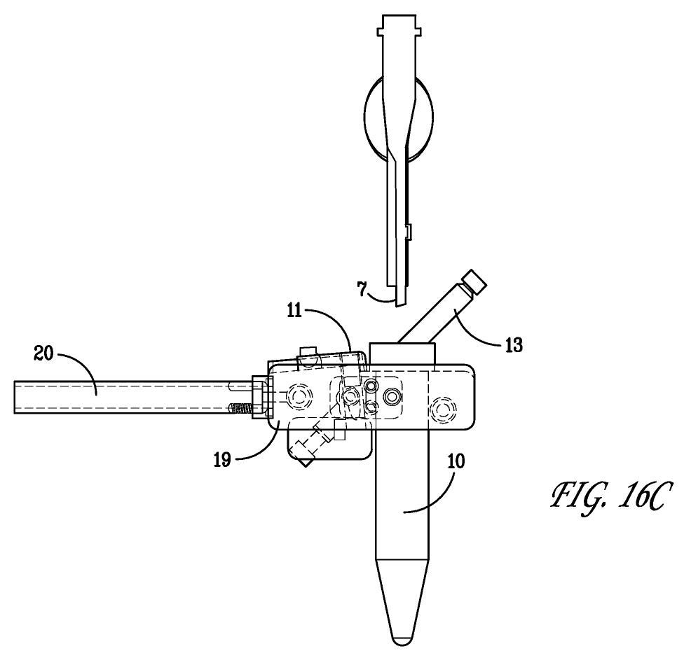

FIG. 14 illustrates an exploded perspective view embodiment of a micropurification card of the present invention including a molecular capture region cartridge. In this embodiment, the molecular capture region cartridge includes a micro-array comprising a plurality of probes, which include positive control, negative control, and Tentacle™ probes.

FIG. 15: Elution Tip in connection with Sample collection Vial. Here is a close-up of two different angles of the elution tip (7) and it's connection with the sample collection vial (11). Note that the elution tip and the sample vial are at a slight angle. This facilitates the transfer of the sample from tip to vial.

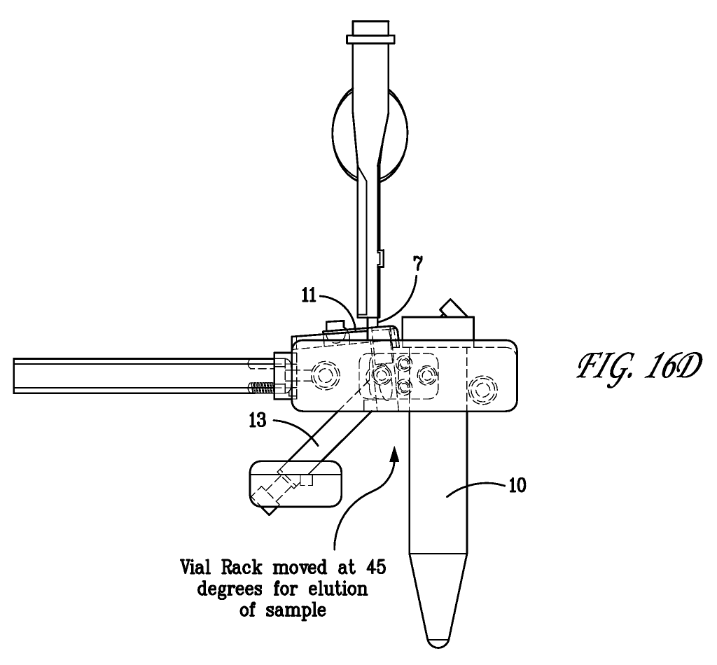

FIG. 16A: Position 1: Collection vials can be inserted or removed from holder along the loading rails (12). The holder is inserted and pulled out from the system using the vial loading handle (20 not pictured) from the card for easy access. The Collection Vial holder (19) holds both the sample (11) and filtrate (10) vials.

FIG. 16B: Position 2: As the collection vial holder is fully inserted the filtrate vial is aligned under the elution tip. This is the same image as position 3, just at a 90 degree angle.

FIG. 16C: Position 3: A 90 degree version of position 2. The discard vial (10) is aligned under the elution tip (7) for collection of lysate and wash eluant. In the current drawing the elution tip is approximately 3 mm from the top of the filtrate vial, this is for view purposes only and the tip will be within 1.5 mm of the top to limit any splatter of filtered eluant.

FIG. 16D: Position 4: Holder slides up along a 45 degree angle on the position change rails (13) and the elution tip (7) is brought into contact with the side of the collection vial (11). The angle is set to 45 degrees to miss the filtrate vial (10) and come in contact with one edge of the collection vial. A more detailed picture of this interaction was previously supplied.

Description of operation of the micropurification card. One example of a micropurification card combines the lysing of cells with a trapping material for extraction and concentration of biomolecules in complex mixtures. The micropurification card superheats samples under flow conditions. Super heating is achieved by pressurizing the sample during the flow. Additionally by using flow in a capillary the temperature and more specifically the time at temperature is easily controlled. The pressure can be achieved by using a flow restriction in the form of a small diameter capillary. This same flow restriction can be achieved by utilizing a capture region in a capillary.

Polymer materials minimize the dead volume of the trapping area, decrease diffusion distances for binding events, and increase the surface area for interactions between the sample and modified surface. By using a Glycidal linked methacrylate as one of the monomer precursors the surface is easily modified using amine linked chemistries. In the case of trapping mRNA's an amine linked oligo dT is attached to the polymer material surface. A possible alternative to the polymer material is the use of silica beads to form the capture region in the capillary. This can also be an advantage because the surface is easy to modify, many of the early patents covering the modification of silica surfaces have expired and are free to use. Polymer monolithic materials can also be used.

There are some considerations that need to be addressed in connecting the lysis module to the capture module. First in any time during lysis there will be extra material generated that is not soluble in solution. Examples are cell membranes and any material that has been used during the growth or collection of the sample. These particles can cause problems by clogging the capture region and preventing flow of the sample through the integrated device. To prevent unwanted particle reaching the capture region the sample needs to be filtered. In the current embodiment, off the shelf filters (with 0.5-2 um pore sizes) were used, which may have similar pore sizes to the capture material but have a much larger surface area to trap the particulate.

Buffers. Ethylene glycol and water based buffers can be used. Suitable buffers can have a pH of 3-8 (acids are useful for breaking open spores), with and without detergents ˜0.5% SDS by volume. Tris and phosphate can be used as buffering agents.

Procedure for using the micropurification card and system. Transfer sample to appropriate buffer (as previously described this is typically a phosphate buffer at a pH of 7). Pipette sample in top of micropurification card (pictured previously). The current embodiment can handle between 10 uL-1 mL of sample, with an suitable volume of 200-500 uL. After loading the sample, the micropurification card is fluidically connected to a pump. This is achieved by connecting a syringe to the fitting where the sample was loaded, the syringe is connected with a luer-lock fitting. The fluid flow is generated by putting the syringe in a syringe pump. (Both the syringe and syringe pump are commercially available).

The sample is force flowed from the sample loading to the lysis region. The lysis region is thermally controlled (by resistive heating or TEC) to a temperature of 100-150 degrees Celsius. The temperature needed is dependant on the biological being lysed. The heating can also be used to control the base pair length of the NA's. The residence time in the lysis region is ˜45 seconds. The length of the lysis region is anywhere from 3-5 cm. The sample flows through a 360/150 um fused silica capillary (from poly micro).

After lysis the sample is sent through a filter to eliminate any particulates left from lysis. The typical filter size is 0.2 to 5 um. (Filters are off the shelf components). The filter is heated to ensure that the solubilized NA's remain denatured, and do not stick to the filter. The temperature is controlled to 90-100 degrees Celsius.

The sample next is flowed into the capture region. The capture region serves two purposes; the first is to generate the pressure needed to prevent boiling of the sample in the lysis region, the second is the trapping and concentration of the sample. The pore size of the capture region in conjunction with the flow rate control the pressure generated during lysis. The surface of the Capture region is modified to have oligo dT chains for trapping mRNA. The surface can also be treated to trap and concentrate any specific sequence or super family of genes. Trapping of the sample is achieved by hybridization of specific NA sequences, or surface energy interactions for extraction of all genomic DNA.

To achieve a more efficient extraction of the NA's the temperature is controlled. Preferred temperatures for hybridization are 45-55 degrees Celsius. The large surface area of the Capture region section allows for trapping of up to 10 ug of NA in a 3cm section. Additionally the dead volume of the trapping region is ˜0.5 uL, and this can be fully eluted in a sample volume of 1-10 uL.

Elution of the sample is achieved using heat to denature the hybridized NA's. The elution buffer is not specific and can be varied. Previous experiments have shown that the same buffer can be used as the lysis buffer. But if a specific buffer is needed later in the sample flow, the sample can be eluted in any buffer.

Protocols For Easy-To-Lyse Mammalian Cells.

1. ATA Buffer System. This approach (FIG. 17) users ATA (aurin tricarboxylic acid) for lysis at room temperature and RNA stabilization. ATA Lysate is prepared from cell pellets by homogenization in ATA Lysis buffer (see below). To purify mRNA, ATA Lysate is first passed through a 0.45 μm filter, to shear genomic DNA and remove cell debris, heated to denature mRNA, and then flowed across an oligo dT support. The support is washed to remove ATA and contaminants (genomic DNA, ribosomal RNA, protein, carbohydrate, lipid, etc), and the RNA is eluted. Elution is effected by a combination of low salt and heat.

ATA is a small polyanionic molecule (and a red dye) with aromatic character that is a general inhibitor of protein-nucleic acid interactions. It may be a more potent RNase inhibitor than GuSCN, but it may also decrease hybridization efficiency (base pairing). ATA polymerizes in solution and may act as nucleic acid mimic that both competes with nucleic acids for protein binding sites, and also associates with nucleic acids, presumably through stacking of aromatic rings. The fact that ATA is a “targeted” ribonuclease inhibitor, rather than a “untargeted” denaturant like GuSCN may explain why it is a more effective RNA protectant, and why it can be used at ˜500× lower concentrations than GuSCN. However, the functionality of RNA prepared with ATA in either microarray hybridization, PCR, or other enzyme-mediated reactions remains to be determined.

A suitable ATA Lysis Buffer is 25 mM Tris pH 7, 150 mM NaCl, 0.1% Tween 20, 10 mM ATA. In this buffer, efficient cell lysis at room temperature uses 10 mM ATA. Lysis of mammalian cells by ATA has not been previously reported. ATA Lysis Buffer may simultaneously lyse cells and stabilize RNA, at least as effectively as GuSCN. Increased salt concentration (e.g.,500 mM NaCl) may be necessary, additional surfactants (e.g., SDS, deoxycholate, sarcosine), or GuSCN may be added.

ATA is removed prior to elution. Ambion's RiboPure kit can effectively remove ATA from RNA. This kit employs organic extraction with TRI Reagent (phenol, GuSCN, salt mixture), followed by purification on silica membrane. ATA appears to partition into both organic and aqueous phases during extraction, but then flow through the silica membrane. RNA eluted from the membrane appears ATA-free (no red color). Possibly, GuSCN promotes RNA denaturation and dissociation of any RNA-bound ATA. Unlike RNA, ATA does not appear to bind to silica in GuSCN buffer.

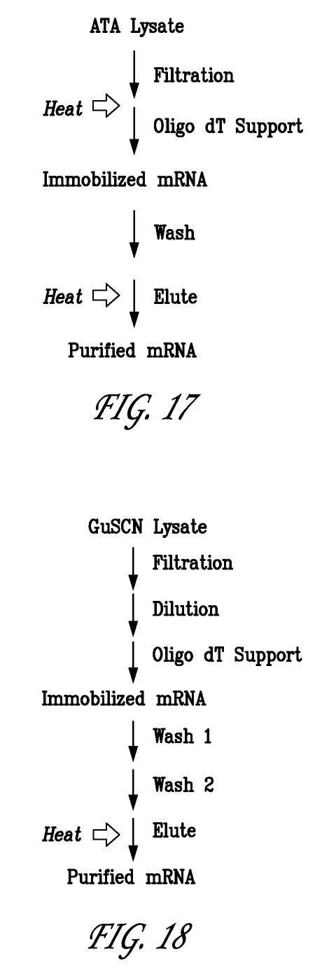

2. GuSCN Buffer System. This approach (FIG. 18) uses conventional GuSCN buffers to purify mRNA on oligo dT. Dilution is used, presumably because mRNA will not bind to oligo dT in full-strength (4-6M) GuSCN buffer. All of the considerations outlined previously for ATA Buffer System apply here. In particular, GuSCN is removed prior to elution as it a potent denaturant and PCR inhibitor. Removal of GuSCN is accomplished with two different wash buffers in these commercial protocols.

3. General Considerations. ATA can be used at 10 mM (100× lower concentration). ATA may require a dilution step as above for GuSCN.

The table below estimates the oligo dT cellulose bed volume and the packed cell (pellet) volume required for two different common microarray labeling protocols.

| | polyA + | | Oligo dT | | Cell Pellet |
|---|---|---|---|---|---|
| | mRNA | Total RNA | BV | Cells | Volume |
| Unamp- | 0.5-5 μg | 50-500 μg | 5-50 μg | 3e6-3e7 | 20-200 μl |
| lified | | | | | |
| μArray | | | | | |
| Labeling | | | | | |
| Amplified | 0.01-0.1 μg | 1-10 μg | 0.1-1 μl | 5e4-5e5 | 0.4-4 μl |
| μArray | | | | | |
| Labeling | | | | | |

Estimated based on: 1% mRNA in total RNA; 10 mg/ml total RNA binding capacity for oligo dT; 20 picogram total RNA/cell; 250 μl/3e7 cells packed cell volume.

Cell lysate volumes are estimated to be 10× cell pellet volumes, both to avoid significant dilution of lysis buffers and to reduce viscosity. Wash steps typically use 3-10 bed volumes, and elution may require at least one bed volume.

The technologies described herein can be used in the detection of biological entities, for example, biological threat agents.

The MCP system can be combined with a suitable assay system, such as Tentacle™ probes, Arcxis Biotechnologies, Pleasanton, Calif., and a sample to answer system. A suitable MCP sample preparation system, as described herein, can perform sample lysis and macromolecule extraction in the time frame of on the order of three minutes. The system device and micropurification card enable the isolation of mRNA, RNA and DNA from whole cells using push button operation. Summary of the Lysis System: 1) Lysis of Bacterial spores, bacteria and eucaryotic cells 2) isolation of DNA, RNA and mRNA 3) Construction of inexpensive consumable device for rapid sample preparation.

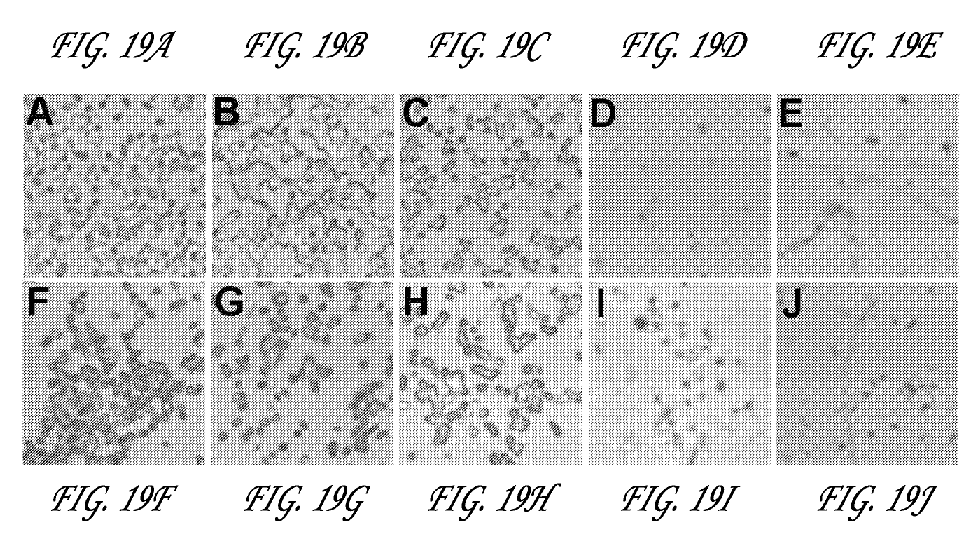

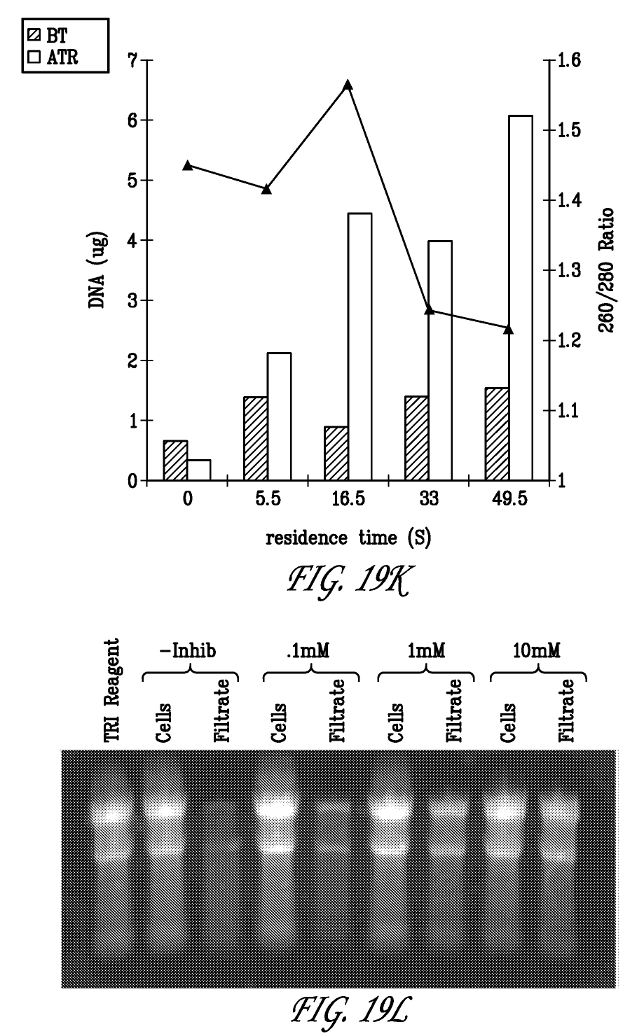

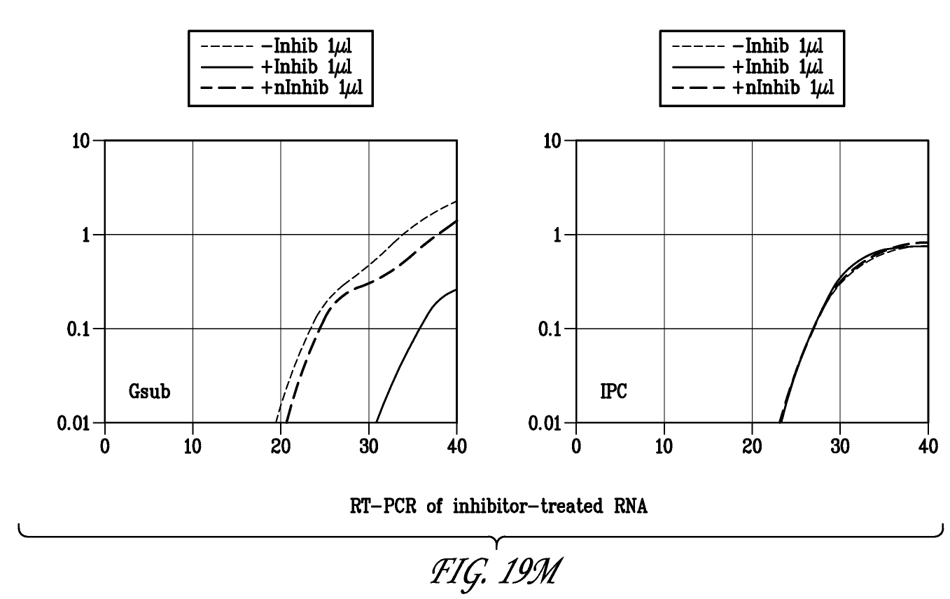

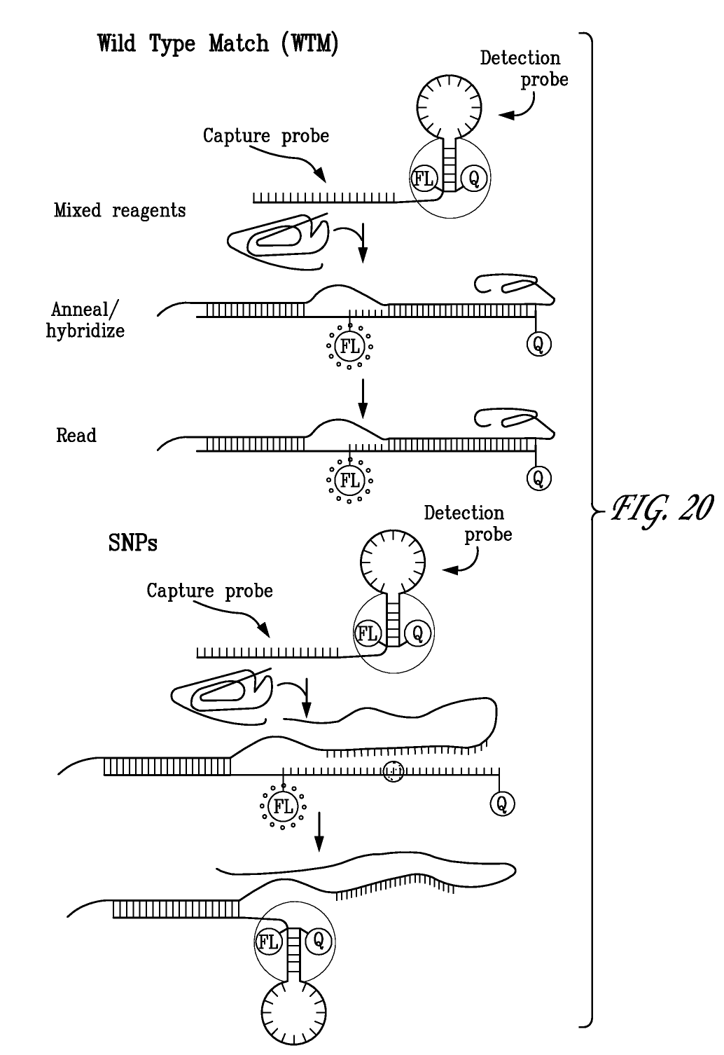

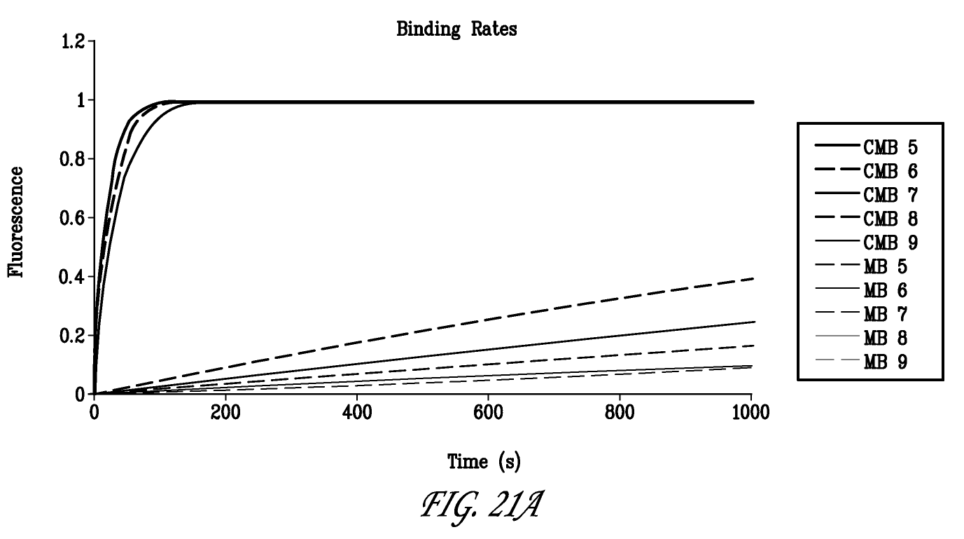

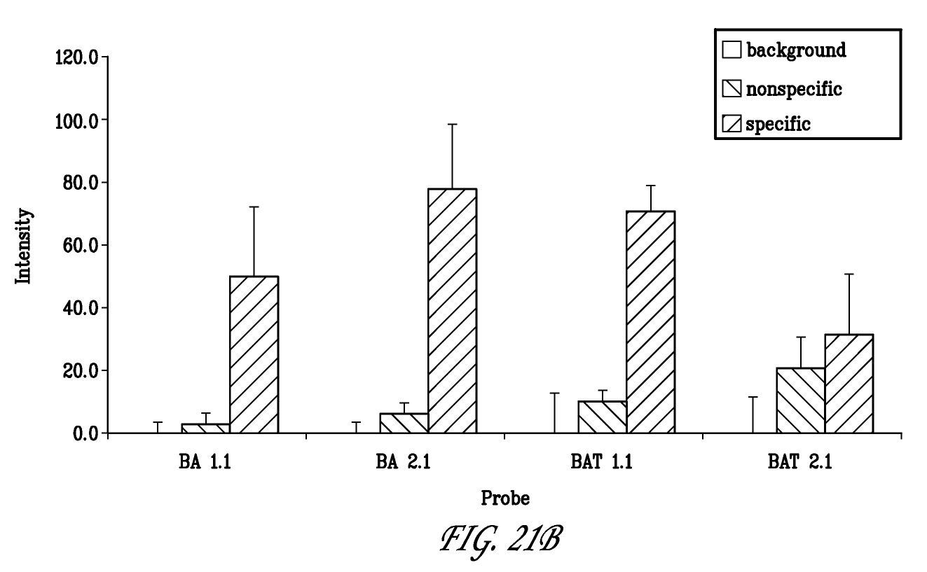

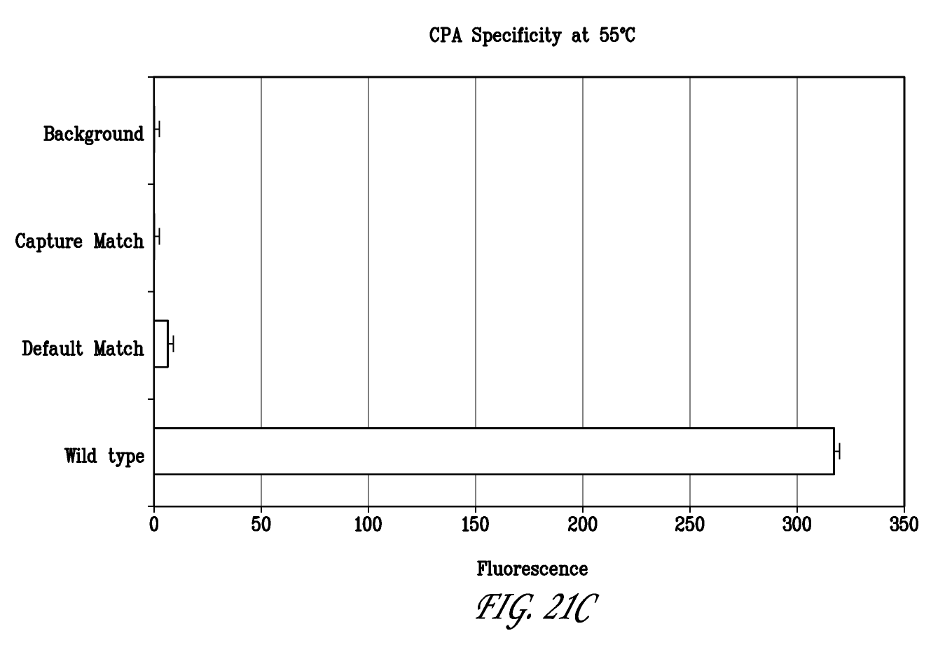

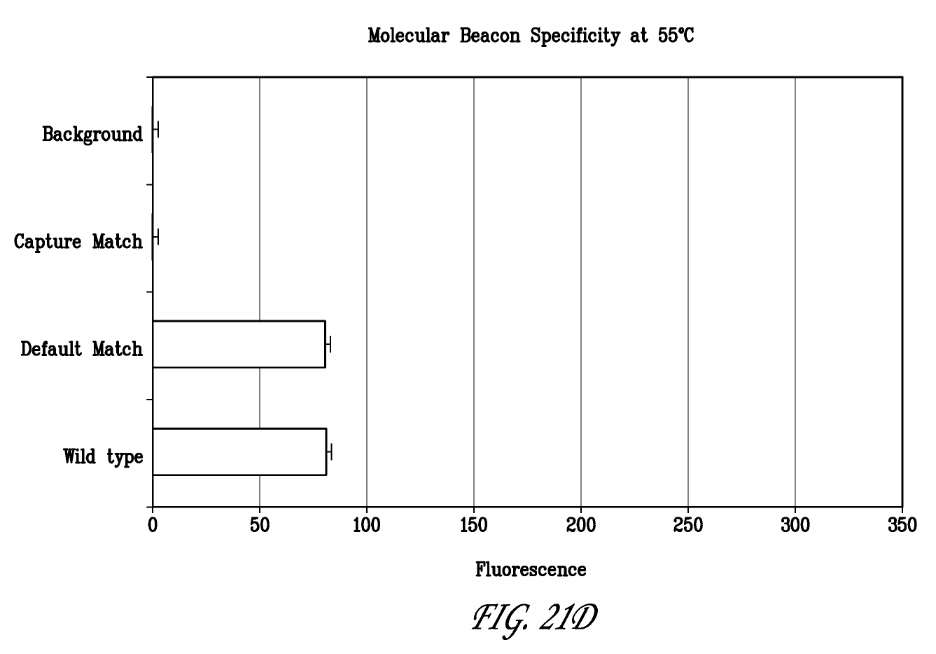

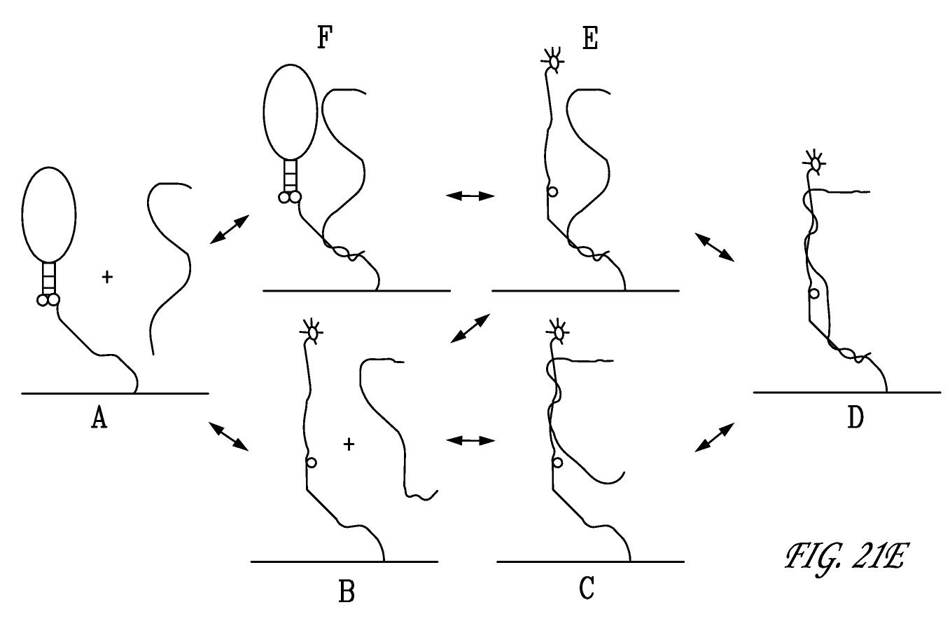

Lysis of Bacterial spores and the effect of superheating on the quality of nucleic acids. FIG. 19 illustrates Bacterial spores Bacillus Atropheus (ATR), and Bacillus thurengensis (BT) were lysed in a pressurized superheated chamber for various amount of time (A-J). As the residence time of the spores in the lysis chamber increased the amount of DNA liberated increased. It was observed at longer time period that the quality of the DNA, as measured by the A260/280 ratio was variable (K). Control spores (A & F) had low amount of liberated DNA, and with and absorbance ratio of approximately 1.45 as the residence time increased, the amount of liberated DNA increased. The quality of the DNA also increased to as high as 1.55 for both ATR (B-E) and BT (G-J) but then dramatically decreases, presumably as the DNA was degraded under the conditions (K). Several studies were also performed to demonstrate the effect of using a nuclease inhibitor under these high temperature conditions. As seen in the agarose gel (L) increasing concentrations of the inhibitor decreased the amount of nucleic acid (RNA) degradation. These preparation were then washed to remove the inhibitor, and then shown to effective used in an rtPCR reaction (M). The results demonstrate the ability to liberate various nucleic acid forms and the conditions required to maintain high quality nucleic acids, and subsequently use the purified material in downstream analytical procedures.

Tentacle™ Probes. A new class of label-free affinity reagents, Tentacle™ Probes, can be implemented. Further details concerning these Tentacle™ probes are disclosed in, “Cooperative Probes and Methods of Using Them”, by Jason A. A. West and Brent A. Satterfield, U.S. provisional patent application serial number 60/850,958, filed on Oct. 10, 2006, Attorney Docket No. ARCX-0004, and international patent application no. PCT/US07/63229 filed on Mar. 2, 2007, the entirety of each application is incorporated by reference herein. These probe molecules increase kinetics up to 200 fold and molecular accuracy in SNP detection by at least 345 fold, with predicted enhancements of near infinite improvement. Because of their cooperative interaction, they allow significant enhancements in sensitivity, specificity and kinetics without the typical tradeoffs. Tentacle™ probe Performance Characteristics: They bind with significantly higher rate constants to reduce assay time, they discriminate on the genotyping level greater than 590,000 times better than monovalent probe molecules; they outperform standard probe molecules (i.e., Taqman, Molecular beacons) for the discrimination of Single Nucleotide polymorphisms (SNPs); they outperform standard probe molecules (i.e., Taqman, Molecular beacons) for the discrimination of insertions/deletions and potentially frame shifts; they have higher signal to noise ratios due to the increased stem strength; they allow for more streamlined design and fabrication using the developed algorithm; they can be designed for DNA or RNA; they are easily attached to a solid surface for array based application; and they can be used in both EXO+ and EXO−taq polymerase qPCR.

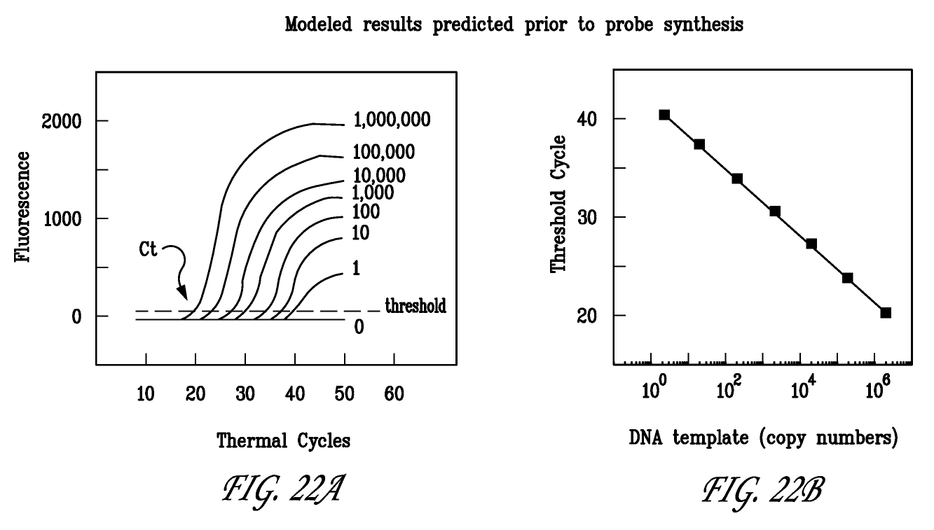

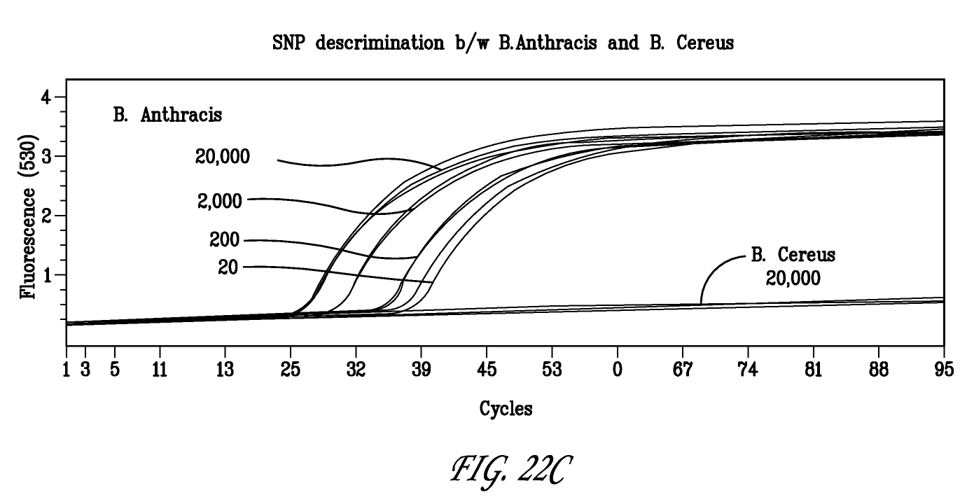

FIG. 20 illustrates Tentacle™ probe design and function.

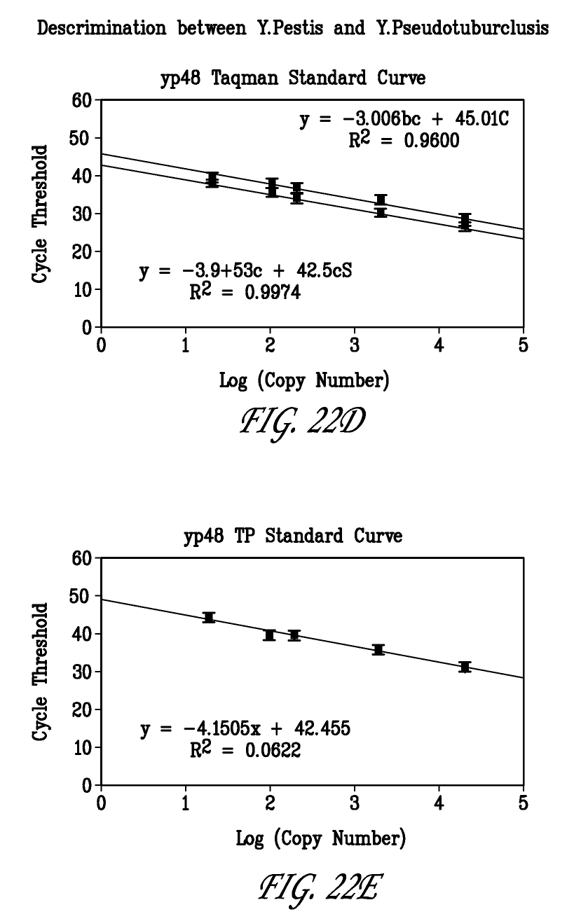

FIG. 21 depicts results with Tentacle™ probes.

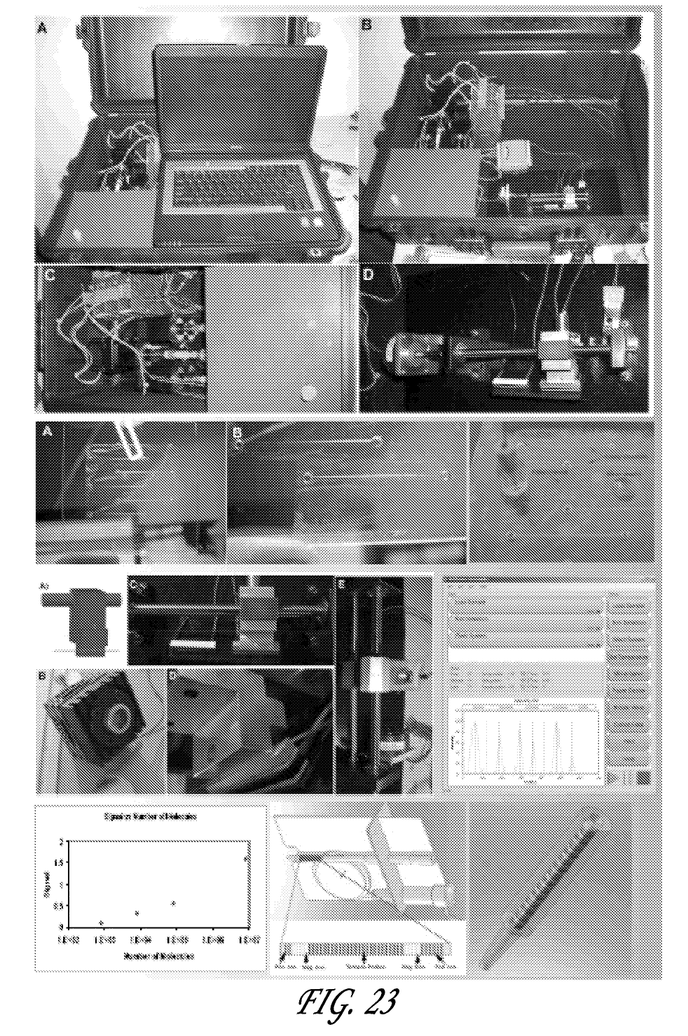

FIG. 22 illustrates external testing results using Tentacle™ probes.

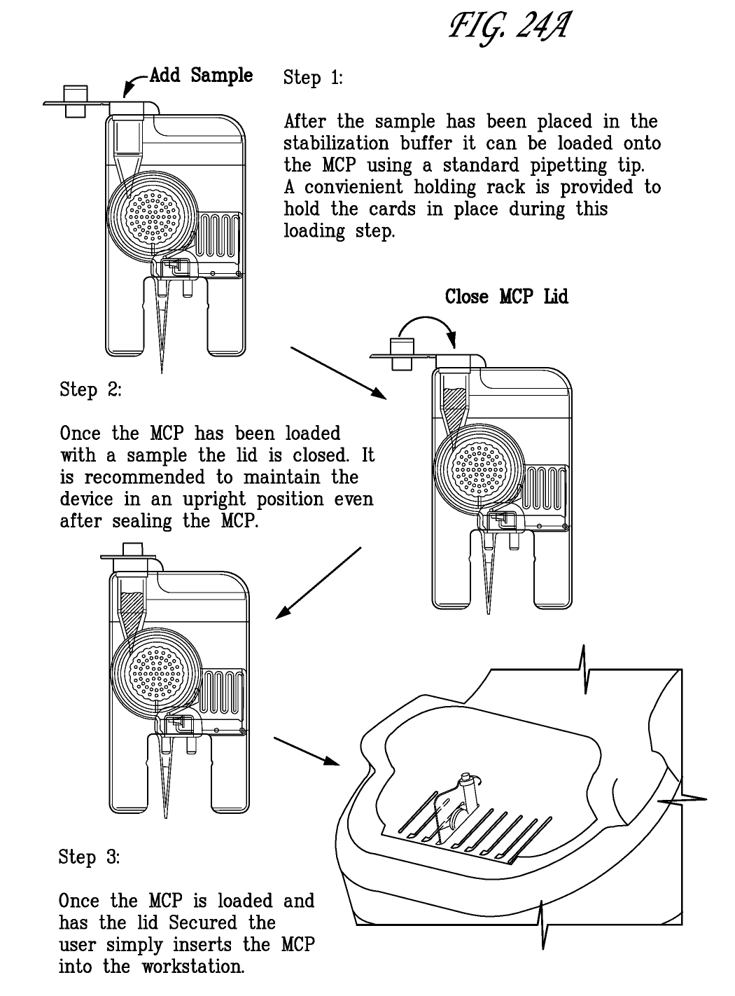

FIG. 23 illustrates a detection system design and fabrication.

Detection system. A first generation of the Detection system was demonstrated. The device contains and on-board sample preparation system, including agent lysis, sample buffering, and associated pumps. The system also contains an integrated analysis system for the detection of the cooperative probe assay. The entire system is controlled by an on-board laptop computer, which performs system control data analysis and reporting. This allows sample preparation of less than 10 minutes including lysis, buffering and analysis. Summary of Detection system system: 1) Fabricated microfluidic microrray device 2) Created new Lysis System for Portable system 3) Designed robust field operable photon counting system 4) field tested system.

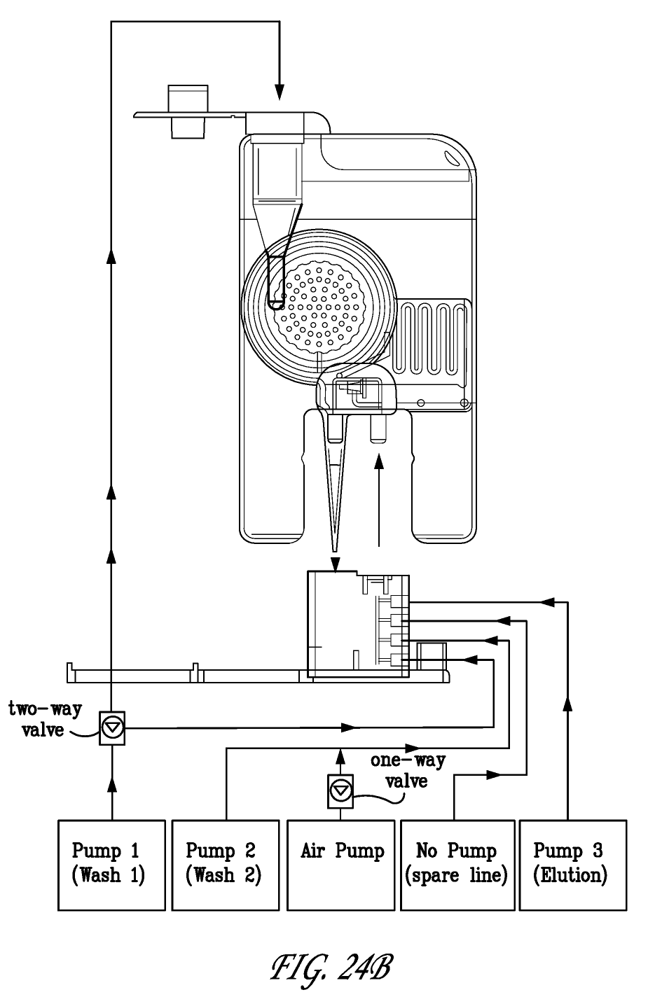

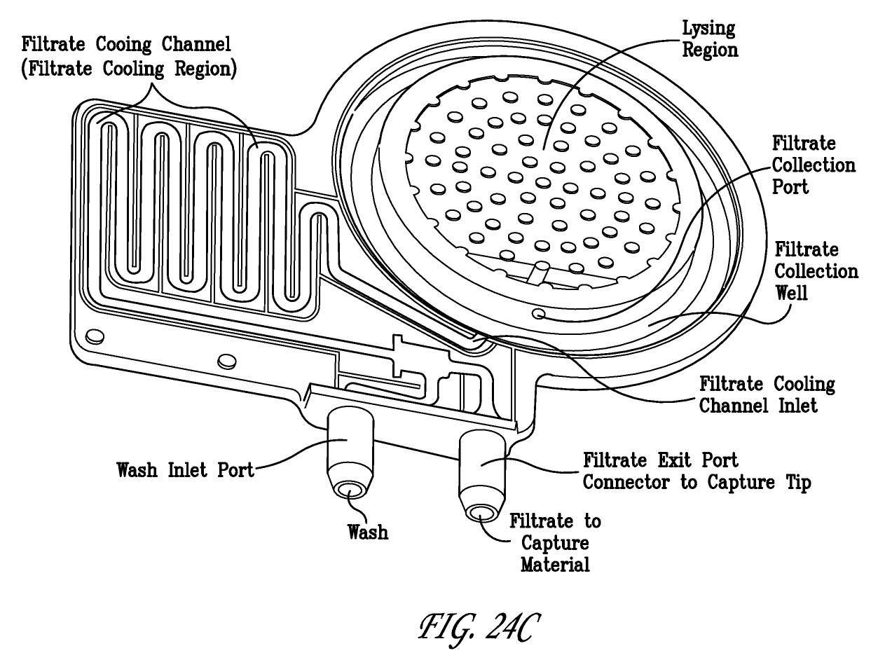

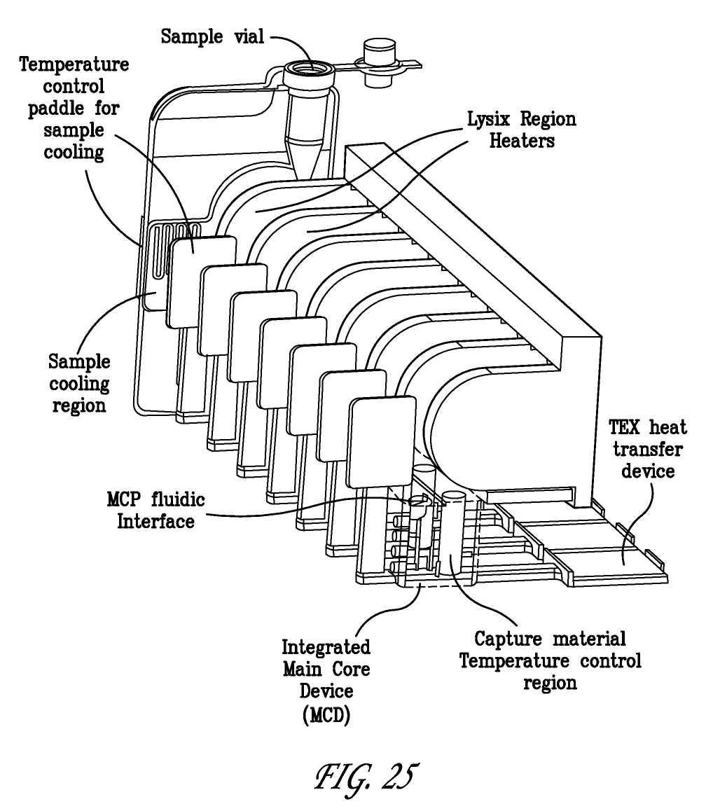

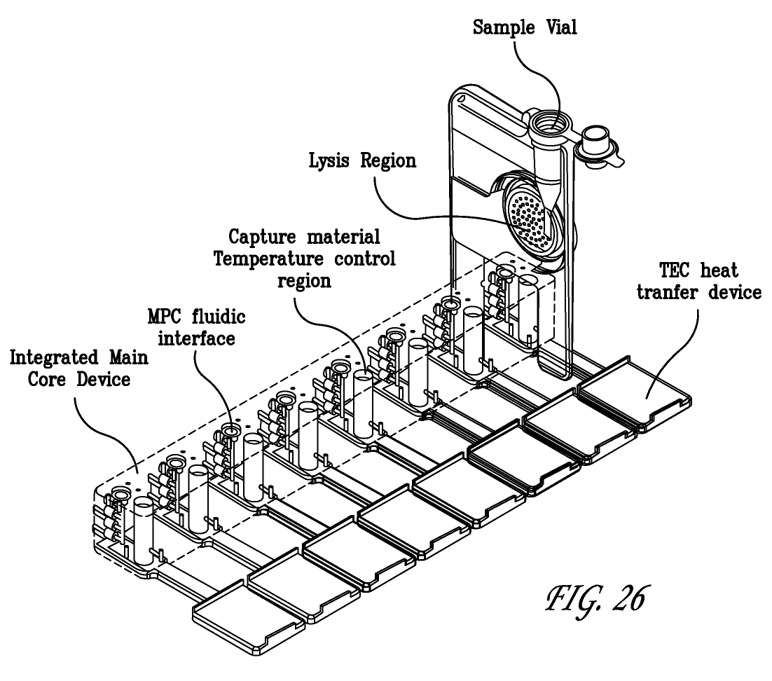

FIG. 24 illustrates a process where the MCP is used in conjunction with the MCP System

FIG. 24b illustrates a process where the card is fluidically controlled by the MCP system

FIG. 24c depicts a design of a cap component of the MCP device.

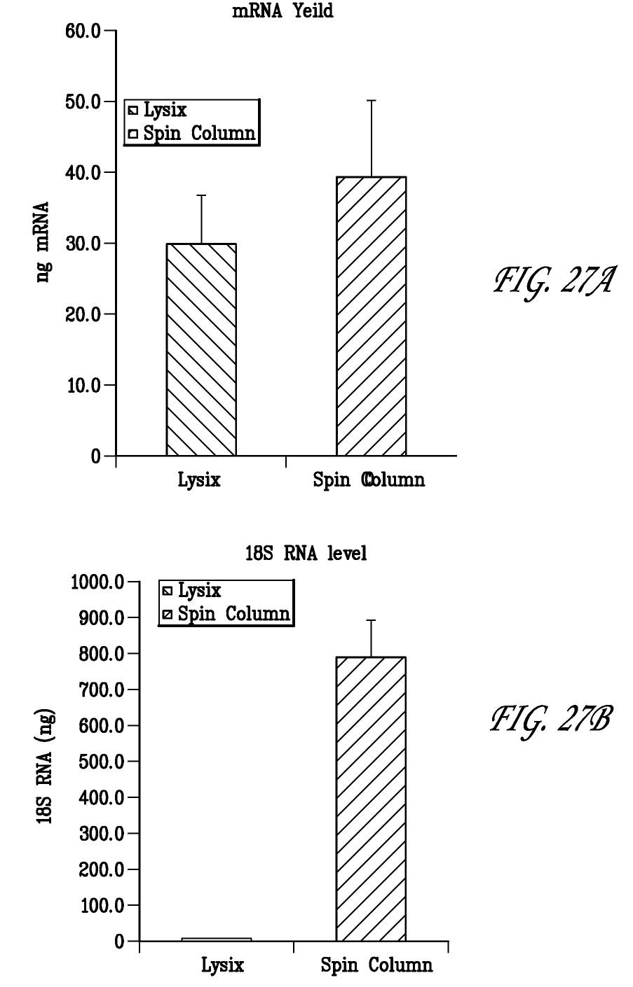

FIG. 25 depicts and assembly for temperature control of a plurality of MCP devices

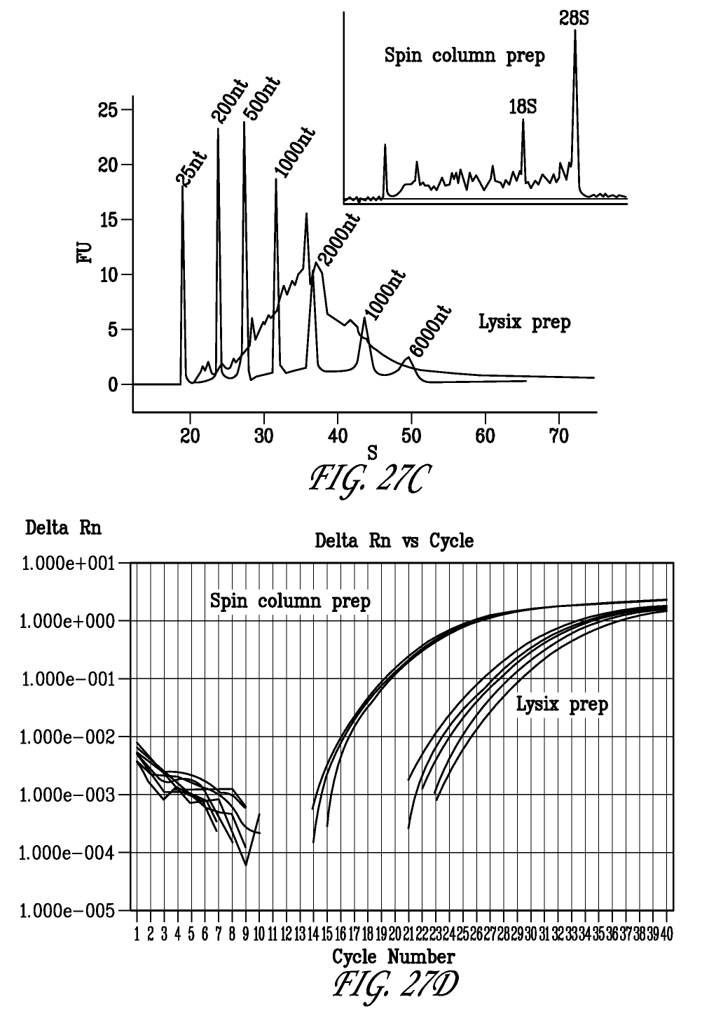

FIG. 26 depicts a second view of the temperature control and fluidic interface of the MCP Workstation with the MCP.

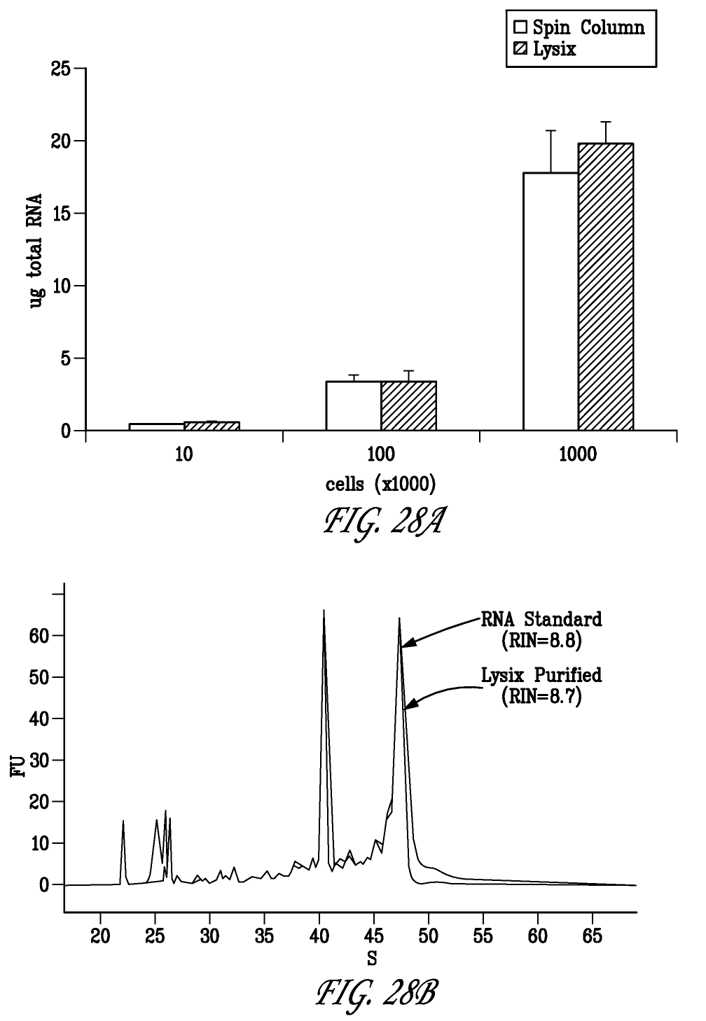

FIG. 27 displays results of mRNA purification using an MCP and MCP system as described herein. In these experiments the yield of mRNA from approximately 200K cells was equivalent compared to conventional spin column kits (A). These purified samples were then further analyzed using real-time PCR and an Agilent Bioanalyzer. Although the actual yield of mRNA was similar, the level of ribosomal RNA was found to be dramatically reduced in the MCP prepared samples (B). Specifically in the MCP prepared samples, the level of 18S RNA contamination was found to be several orders of magnitude less using the MCP system as judged by real-time PCR (B&D). The preparation also appeared to contain little, if any, ribosomal RNA, when they were separated by gel electrophoresis using the Agilent Bioanalyzer (C).

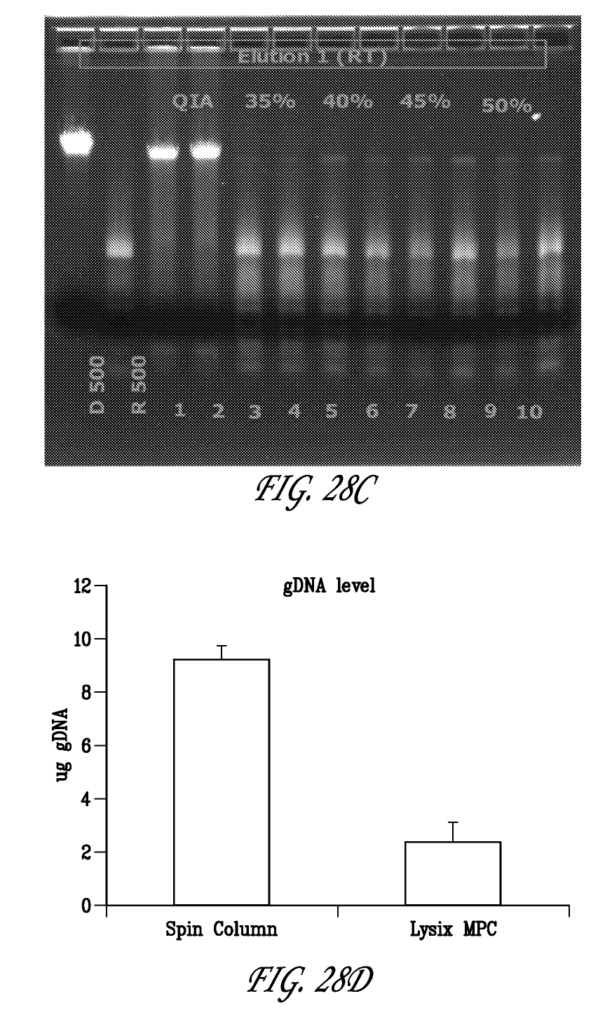

FIG. 28 displays the results of total RNA purification using an MCP and MCP system according to the present invention. Various amounts of cells were conducted by passing whole cells through the MCP without any pre-processing. Results demonstrated that the MCP has equivalent performance to spin column technology in the extraction of total RNA from cryopreserved rat hepatocytes (A). Specifically, the amount of RNA extracted using the systems according to the present invention was not significantly different between conventional spin columns. RNA integrity numbers (RIN) as judged by an Agilent Bioanalyzer™ was also not significantly different for the these cell preparations. To determine whether the MCP system adversely affected the quality of the total RNA preparations, a second set of experiments was performed using purified total RNA that displayed a RIN number of approximately 8.8 (B). These experiments demonstrated that the MCP system does not degrade isolated RNA or significantly affect the quality of RNA as judged by the RIN number generated by the Agilent Bioanalyzer™. Several experiments were further conducted to determine the level of genomic DNA contamination of the total RNA extracted using the MCP (C). Using both agarose gels and real-time PCR determined that the gDNA was significantly lower than found with spin column prepared samples.

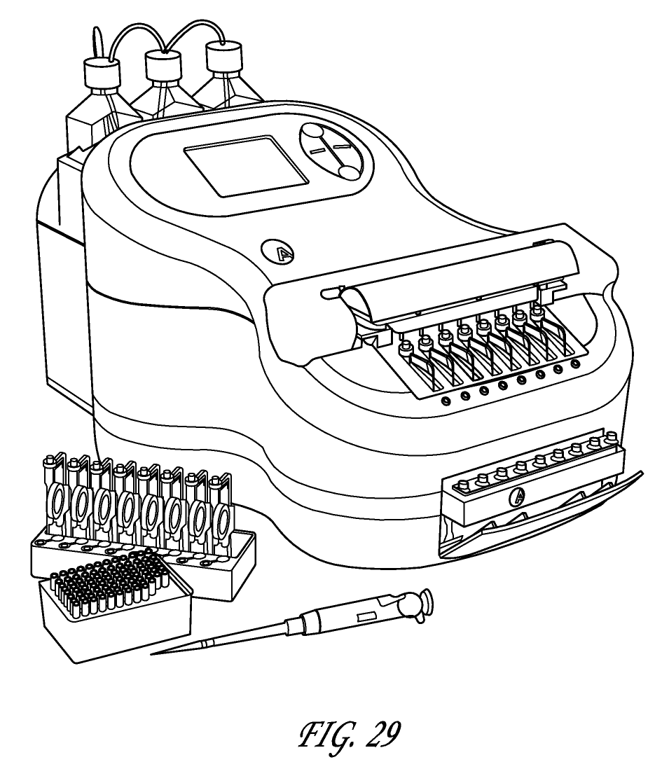

FIG. 29 depicts the assembled MCP system that can accommodate eight MCPs. In other embodiments, suitable MCP systems can handle any number of MCPs, for example 1, or 2, or 3, or 4, or 5, or 6, or 7, or 8, or 9, or 10, or about 12, or about 15, or about 20, or even more.

### Example 1

Total RNA from Cells. The following example is an exemplary use of the micropurification cards (MCPs) and hardware system. Total RNA is isolated from cell suspensions. Cell cultures containing from about 100 to about a million intact cells are first centrifuged at low speed to pellet the intact cells. The cell media is then aspirated and discarded. Afterwards 500 μl of a total RNA stabilization buffer, which contains GuSCN (3.5 M), Triton X-100 (1.3%) Tris HCL (10 mM) pH 6.4, added to the cell containing vial. The cell pellet now in the stabilization buffer is then vortexed or mixed thoroughly, then deposited into the sample collection vial located on the MCP. The Lid of the device is then closed, and the MCP is inserted into the a slot on the MCP System. Once the card is loaded the hardware station detects the presence of the MCP using an optical sensor. The system then prompts the user to begin the purification procedure. Once the operator depresses the correct switch, the MCP workstation proceeds to transfer the sample located in the sample containment vial, to the lysis region of the MCP, where the sample undergoes heat mediated lysis and denaturation. This sample, having been lysed and denatured, then passes through a filter located in the lysis region which removes the majority of cellular debris. This lysate is then transferred to the analyte capture region where it undergoes affinity based extraction to purify the total RNA via a combination of salt and ethanol precipitation using a silica based material. During this transfer, and prior to the sample contacting the capture material the sample is mixed with 100% Ethanol to promote the binding of the nucleic acids on to the capture tip. Once the target analytes are bound the workstation continues a series of two wash steps to remove non-specifically isolated material and to remove salts and detergents used in the isolation of the total RNA. The first of these wash steps contains a buffer that includes GuSCN (0.15 M), Tris HCL (10 mM), pH 6.4 in EtOH 80%. The isolated sample is then washed a second time with 80% EtOH. The washed sample is then air dried to remove all traces of EtOH before the elution of the sample. When these steps are concluded, the elution tip of the MCP is warmed to 65° C., and the sample is eluted into an external collection vial using either a Tris-EDTA buffer or pure water.

### Example 2

Total RNA from tissues. The following example is an exemplary use of the micropurification cards (MCPs) and the MCP hardware system. Isolation of total RNA from tissue homogenates containing 5-50 mg of animal or plant tissue. Tissues are placed into a minimum of 500 μl of the MCP Total RNA stabilization buffer, which contains GuSCN (3.5 M), Triton X-100 (1.3%) and Tris HCL (10 mM) pH 6.4, which is deposited into the tissue containing vial. This sample is then homogenized using a syringe or alternative device, such as a Polytron™ mixer, or Dounce™ homogenizer. The homogenized sample is centrifuged to remove insoluble material or placed directly into the MCP total RNA card. It is not required to remove all of the insoluble tissue material, but in some case may increase the yield of total RNA from the homogenized sample. After homogenization is complete the sample is then deposited into the sample collection vial located on the MCP. The lid of the MCP is then closed, and is inserted into the a slot on the MCP System. Once the card is loaded the hardware station detects the presence of the MCP using an optical sensor. The system then prompts the user to begin the purification procedure. Once the operator depresses the correct switch, the MCP workstation proceeds to transfer the sample located in the sample containment vial, to the lysis region of the MCP, where the sample undergoes heat mediated lysis and denaturation. This sample, having been lysed and denatured, then passes through a membrane filter located in the lysis region which removes the majority of cellular debris. The lysate is then transferred to the analyte capture region where it undergoes affinity based extraction to purify the total RNA via a combination of salt and ethanol precipitation using a silica based material. During this transfer, and prior to the sample contacting the capture material the sample is mixed with 100% Ethanol to promote the binding of the nucleic acids on to the capture tip. Once the target analytes are bound to the capture material the workstation continues a series of two wash steps to remove non-specifically isolated material and to remove salts and detergents used in the isolation of the total RNA. The first of these wash steps contains a buffer that includes GuSCN (0.15 M), Tris HCL (10 mM), pH 6.4 in EtOH 80%, then a second wash step where the isolated sample is washed with 80% EtOH. The washed sample is then air dried to remove all traces of EtOH before the elution of the sample. When these steps are concluded, the elution tip of the MCP is warmed to 65° C., and the sample is eluted into an external collection vial using either a Tris-EDTA buffer or pure water.

### Example 3

Total RNA from blood. The following example is an exemplary use of the micropurification cards (MCPs) and the MCP hardware system. Isolation of total RNA from approximately 1.0 ml of Blood is conducted by mixing the sample in equal volumes (500 ul of blood/500 ul of 2× concentration of stabilization buffer) which contains GuSCN (3.5 M), Triton X-100 (1.3%) Tris HCL (10 mM) pH 6.4, added should be deposited into the blood containing vial. The blood sample can then either be centrifuged to remove insoluble material or placed directly into the MCP Total RNA card. It is not required to remove all of the insoluble tissue material, but in some case may increase the yield of Total RNA from the homogenized sample. The Lid of the MCP is then closed, and is inserted into the a slot on the MCP System. Once the card is loaded the hardware station detects the presence of the MCP using an optical sensor. The system then prompts the user to begin the purification procedure. Once the operator depresses the correct switch, the MCP workstation proceeds to transfer the sample located in the sample containment vial, to the lysis region of the MCP, where the sample undergoes heat mediated lysis and denaturation. This sample, having been lysed and denatured, then passes through a membrane filter located in the lysis region which removes the majority of cellular debris. The lysate is then transferred to the analyte capture region where it undergoes affinity based extraction to purify the total RNA via a combination of salt and ethanol precipitation using a silica based material. During this transfer, and prior to the sample contacting the capture material the sample is mixed with 100% Ethanol to promote the binding of the nucleic acids on to the capture tip. Once the target analytes are bound to the capture material the workstation continues a series of two wash steps to remove non-specifically isolated material and to remove salts and detergents used in the isolation of the total RNA. The first of these wash steps contains a buffer that includes GuSCN (0.15 M), Tris HCL (10 mM), pH 6.4 in EtOH 80%, then a second wash step where the isolated sample is washed with 80% EtOH. The washed sample is then air dried to remove all traces of EtOH before the elution of the sample. When these steps are concluded, the elution tip of the MCP is warmed to 65° C., and the sample is eluted into an external collection vial using either a Tris-EDTA buffer or pure water.

### Example 4

mRNA from Cells. The following example is an exemplary use of the micropurification cards (MCPs) and the MCP hardware system. Isolation of mRNA from cell suspensions for cultures containing from about 100 to about 1×10⁶ cells are first centrifuged at low speed to pellet the intact cells. The cell media is then aspirated and discarded, then 500 μl of the MCP mRNA stabilization buffer, which contains Aurintricarboxylic acid (ATA) (3M), TMAC (2M), Triton X-100, (0.035%), pH (7.4), added to the cell containing vial. The cell pellet now in the stabilization buffer is then vortexed or mixing thoroughly, then deposited into the sample collection vial located on the MCP. The Lid of the device is then closed, and the MCP is inserted into the a slot on the MCP System. Once the card is loaded the hardware station detects the presence of the MCP using an optical sensor. The system then prompts the user to begin the purification procedure. Once the operator depresses the correct switch, the MCP workstation proceeds to transfer the sample located in the sample containment vial, to the lysis region of the MCP, where the sample undergoes heat mediated lysis and denaturation. This sample, having been lysed and denatured, then passes through a filter located in the lysis region which removes the majority of cellular debris. This lysate is then transferred to the analyte capture region where it undergoes affinity based extraction to purify the total RNA via a combination of salt and ethanol precipitation using a silica based material. Once the target analytes are bound the workstation continues a series of two wash steps to remove non-specifically isolated material and to remove salts and detergents used in the isolation of the mRNA. The first of these wash steps contains a buffer that includes TMAC (2M), Triton X-100, (0.035%), pH (7.4), then a second wash step where the isolated sample is washed with TMAC (0.1 M), Triton X-100 (0.125%), pH (7.4). The washed sample is then air dried to remove all traces of wash buffers before the elution of the sample. When these steps are concluded, the elution tip of the MCP is warmed to 75° C., and the sample is eluted into an external collection vial using either a Tris-EDTA buffer or pure water.

### Example 5

mRNA from Tissues. The following example is an exemplary use of the micropurification cards (MCPs) and the MCP hardware system. Isolation of total RNA from tissue homogenates containing 5-50 mg of animal or plant tissue. Tissues placed into a minimum of 500 μl of the MCP mRNA stabilization buffer, which buffer contains Aurintricarboxylic acid (ATA) (3M), TMAC (2M), Triton X-100, (0.035%), pH (7.4), are deposited into a tissue containing vial. This sample is then homogenized using a syringe or alternative device, such as a Polytron mixer, or Dounce homogenizer. The homogenized sample is centrifuged to remove insoluble material or placed directly into the MCP mRNA card. It is not required to remove all of the insoluble tissue material, but in some case may increase the yield of mRNA from the homogenized sample. After homogenization is complete the sample is then deposited into the sample collection vial located on the MCP. The Lid of the MCP is then closed, and is inserted into the slot on the MCP System. Once the card is loaded the hardware station detects the presence of the MCP using an optical sensor. The system then prompts the user to begin the purification procedure. Once the operator depresses the correct switch, the MCP workstation proceeds to transfer the sample located in the sample containment vial, to the lysis region of the MCP, where the sample undergoes heat mediated lysis and denaturation. This sample, having been lysed and denatured, then passes through a filter located in the lysis region which removes the majority of cellular debris. This lysate is then transferred to the analyte capture region where it undergoes affinity based extraction to purify the total RNA via a combination of salt and ethanol precipitation using a silica based material. Once the target analytes are bound, the workstation continues a series of two wash steps to remove non-specifically isolated material and to remove salts and detergents used in the isolation of the mRNA. The first of these wash steps contains a buffer that includes TMAC (2M), Triton X-100, (0.035%), pH (7.4). The isolated sample is then washed a second time with TMAC (0.1 M), Triton X-100 (0.125%), pH (7.4). The washed sample is then air dried to remove all traces of wash buffers before the elution of the sample. When these steps are concluded, the elution tip of the MCP is warmed to 75° C., and the sample is eluted into an external collection vial using either a Tris-EDTA buffer or pure water.

### Example 6

mRNA from Blood. The following example is an exemplary use of the micropurification cards (MCPs) and the MCP hardware system. Isolation of mRNA from approximately 1.0 ml of Blood is conducted by mixing the sample in equal volumes (500 ul of blood/500 ul of Stabilization buffer) with a 2× concentration of the stabilization buffer which contains Aurintricarboxylic acid (ATA) (3M), TMAC (2M), Triton X-100, (0.035%), pH (7.4). The blood sample now in the stabilization buffer is then vortexed or mixing thoroughly, then deposited into the sample collection vial located on the MCP. The Lid of the device is then closed, and the MCP is inserted into the a slot on the MCP System. Once the card is loaded the hardware station detects the presence of the MCP using an optical sensor. The system then prompts the user to begin the purification procedure. Once the operator depresses the correct switch, the MCP workstation proceeds to transfer the sample located in the sample containment vial, to the lysis region of the MCP, where the sample undergoes heat mediated lysis and denaturation. This sample, having been lysed and denatured, then passes through a filter located in the lysis region which removes the majority of cellular debris. This lysate is then transferred to the analyte capture region where it undergoes affinity based extraction to purify the total RNA via a combination of salt and ethanol precipitation using a silica based material. Once the target analytes are bound the workstation continues a series of two wash steps to remove non-specifically isolated material and to remove salts and detergents used in the isolation of the mRNA. The first of these wash steps contains a buffer that includes TMAC (2M), Triton X-100, (0.035%), pH (7.4), then a second wash step where the isolated sample is washed with TMAC (0.1M), Triton X-100 (0.125%), pH (7.4). The washed sample is then air dried to remove all traces of wash buffers before the elution of the sample. When these steps are concluded, the elution tip of the MCP is warmed to 75° C., and the sample is eluted into an external collection vial using either a Tris-EDTA buffer or pure water.

### Example 7

Genomic DNA from Cells. The following example is an exemplary use of the micropurification cards (MCPs) and the MCP hardware system. Isolation of gDNA from cell suspensions for cultures containing from about 100 to about a million cells are first centrifuged at low speed to pellet the intact cells. The cell media is then aspirated and discarded. Then 500 μl of the MCP gDNA stabilization buffer, which contains GuHCl (3.5 M), Triton X-100 (1.3%) Tris HCL (10 mM) pH 6.4, is added to the cell containing vial. The cell pellet now in the stabilization buffer is then vortexed or mixed thoroughly, then deposited into the sample collection vial located on the MCP. The Lid of the device is then closed, and the MCP is inserted into the a slot on the MCP System. Once the card is loaded the hardware station detects the presence of the MCP using an optical sensor. The system then prompts the user to begin the purification procedure. Once the operator depresses the correct switch, the MCP workstation proceeds to transfer the sample located in the sample containment vial to the lysis region of the MCP, where the sample undergoes heat mediated lysis and denaturation. This sample, having been lysed and denatured, then passes through a filter located in the lysis region which removes the majority of cellular debris. This lysate is then transferred to the analyte capture region where it undergoes affinity based extraction to purify the gDNA via a combination of salt and ethanol precipitation using a silica based material. Once the target analytes are bound the workstation continues a series of two wash steps to remove non-specifically isolated material and to remove salts and detergents used in the isolation of the gDNA. The first of these wash steps contains a buffer that includes GuSCN (0.15 M), Tris HCL (10 mM), pH 6.4 in EtOH 80%, then a second wash step where the isolated sample is washed with 80% EtOH. The washed sample is then air dried to remove all traces of EtOH before the elution of the sample. When these steps are concluded, the elution tip of the MCP is warmed to 65° C., and the sample is eluted into an external collection vial using either a Tris-EDTA buffer or pure water.

### Example 8

Genomic DNA from Tissues. The following example is an exemplary use of the micropurification cards (MCPs) and the MCP hardware system to isolate gDNA from tissue homogenates containing 5-50 mg of animal or plant tissue. Tissue is placed into a minimum of 500 μl of the MCP gDNA stabilization buffer, which contains GuHCl (3.5 M), Triton X-100 (1.3%) and Tris HCL (10 mM) at pH 6.4, which is deposited into a tissue containing vial. This sample is then homogenized using a syringe or alternative device, such as a Polytron mixer, or Dounce homogenizer. The homogenized sample is centrifuged to remove insoluble material or placed directly into the MCP gDNAcard. It is not required to remove all of the insoluble tissue material, but in some cases it may increase the yield of gDNA from the homogenized sample. After homogenization is complete the sample is then deposited into the sample collection vial located on the MCP. The lid of the MCP is then closed, and the MCP is inserted into a slot on the MCP System. Once the card is loaded the hardware station detects the presence of the MCP using an optical sensor. The system then prompts the user to begin the purification procedure. Once the operator depresses the correct switch, the MCP workstation proceeds to transfer the sample located in the sample containment vial, to the lysis region of the MCP, where the sample undergoes heat mediated lysis and denaturation. This sample, having been lysed and denatured, then passes through a filter located in the lysis region which removes the majority of cellular debris. This lysate is then transferred to the analyte capture region where it undergoes affinity based extraction to purify the gDNA via a combination of salt and ethanol precipitation using a silica based material. Once the target analytes are bound to the capture material, the workstation continues a series of two wash steps to remove non-specifically isolated material and to remove salts and detergents used in the isolation of the gDNA. The first of these wash steps contains a buffer that includes GuSCN (0.15 M), Tris HCL (10 mM), pH 6.4 in EtOH 80%, then a second wash step where the isolated sample is washed with 80% EtOH. The washed sample is then air dried to remove all traces of EtOH before the elution of the sample. When these steps are concluded, the elution tip of the MCP is warmed to 65° C., and the sample is eluted into an external collection vial using either a Tris-EDTA buffer or pure water.

### Example 9

Genomic DNA from blood. The following example is an exemplary use of the micropurification cards (MCPs) and the MCP hardware system. Isolation of genomic DNA from approximately 1.0 ml of Blood is conducted by mixing the sample in equal volumes (500 ul of blood/500 ul of 2× concentration of stabilization buffer) which contains GuSCN (3.5 M), Triton X-100 (1.3%) Tris HCL (10 mM) pH 6.4, added should be deposited into the blood containing vial. The blood sample can then either be centrifuged to remove insoluble material or placed directly into the MCP genomic DNA card. It is not required to remove all of the insoluble tissue material, but in some case may increase the yield of genomic DNA from the homogenized sample. The Lid of the MCP is then closed, and is inserted into the a slot on the MCP System. Once the card is loaded the hardware station detects the presence of the MCP using an optical sensor. The system then prompts the user to begin the purification procedure. Once the operator depresses the correct switch, the MCP workstation proceeds to transfer the sample located in the sample containment vial, to the lysis region of the MCP, where the sample undergoes heat mediated lysis and denaturation. This sample, having been lysed and denatured, then passes through a membrane filter located in the lysis region which removes the majority of cellular debris. The lysate is then transferred to the analyte capture region where it undergoes affinity based extraction to purify the genomic DNA via a combination of salt and ethanol precipitation using a silica based material. During this transfer, and prior to the sample contacting the capture material the sample is mixed with 100% Ethanol to promote the binding of the nucleic acids on to the capture tip. Once the target analytes are bound to the capture material the workstation continues a series of two wash steps to remove non-specifically isolated material and to remove salts and detergents used in the isolation of the total RNA. The first of these wash steps contains a buffer that includes GuHCl (0.15 M), Tris HCL (IOmM), pH 6.4 in EtOH 80%, then a second wash step where the isolated sample is washed with 80% EtOH. The washed sample is then air dried to remove all traces of EtOH before the elution of the sample. When these steps are concluded, the elution tip of the MCP is warmed to 65° C., and the sample is eluted into an external collection vial using either a Tris-EDTA buffer or pure water.

### Example 10

In this example, an MCP system, is a fully automated system that can purify, separately, DNA, total RNA or mRNA. The system includes a micro purification card (“MCP” or “Lysix card”), optimized for genomic DNA, total RNA or mRNA applications. The system is designed to obtain and purify nucleic acids from a variety of tissue and cell samples that are loaded into the MCP. The MCP system is capable of analyzing eight samples (i.e., eight MCPs) simultaneously in about 10 minutes to ensure high quality data for downstream applications, such as PCR amplification. Each MCP can handle sample sizes containing from about 100 cells to about one million cells, which is equivalent to about 1 to about 50 mg of homogenized tissue.

Preparation of Biological Samples.

Total RNA Samples. Biological samples for total RNA analysis are prepared using a buffer (binding buffer, stabilization buffer) that comprise the following components: guanidinium isothiocyanate (GuSCN), 5.25 molar (M); tris-HCl, 1 M; pH 6.4; 50 mls water. Tissue can be homogenized with the binding buffer or cells can be first dispersed in the binding buffer. The dispersion of cells in the binding buffer is then added to the vial portion of the card, and the cells are processed as described hereinabove.

mRNA Samples. Biological samples for an RNA analysis are prepared using any binding buffer that comprises the following components: aurin tricarboxylate (“ATA”), 10 mmol; glycerol 20% by volume; trimethylammonium chloride (“TMAC”); Triton X-100, 0.025%; and water, total volume about 200 mls. Tissue can be homogenized with the binding buffer or cells can be first dispersed in the binding buffer. The dispersion of cells in the binding buffer is then added to the vial portion of the card, and the cells are processed as described hereinabove.

Genomic DNA. Biological samples for genomic DNA analysis are prepared using any binding buffer that comprises the following components: GuHCl, 5.25 M; Tris HCl, 1.0 M; pH 6.4, water 50 mls. Tissue can be homogenized with the binding buffer or cells can be first dispersed in the binding buffer. The dispersion of cells in the binding buffer is then added to the vial portion of the card, and the cells are processed as described hereinabove.

Processing of Biological Samples. The MCP workstation and the micro purification cards are illustrated and described in FIGS. 24-26 below. The MCP system includes a specially designed micro purification card (i.e., MCP). These cards are each designed to extract, isolate and purify genomic DNA, total RNA, or mRNA from cell samples for subsequent use external to the MCP process in applications such as micro-array analysis, real-time PCR, quantitative PCR and Northern blots, among other nucleic acid assays.

The Micropurification Cards. The MCPs (base and filter cover) are injection molded from a cyclic polyolefin resin, which material permits heating of the MCP to temperatures in excess of 130° C. A filter membrane is bonded in place between the lysing region and in the filter cover. Referring to FIG. 24a, temperatures in excess of 130° C. are used during the lysing step in which biological material enters the filter region in a binding buffer, the cells lyse, and the macromolecular contents, including nucleic acids, are filtered through the membrane filter. A filter cover (FIG. 24c), which is separately injection molded from cyclic polyolefin resin, is bonded to the base card and encloses the lysing region. An illustration of the process workflow of the MCP System and micropurification cards is provided in FIGS. 24a, b, c.

An illustration of the processing of sample cells and nucleic acids through the MCP is depicted in FIG. 24a. After the sample cells are dispersed in a stabilization buffer, the dispersed cells are manually injected, e.g., by pipette, into the MCP vial. A holding rack is provided on the workstation to hold the cards in place during this loading step. The vial of the MCP is loaded with a sample, the lid is closed, the MCP is inserted into the MCP workstation, and then the nucleic acids in the biological sample are isolated and purified. Additional details about the processing of biological samples are described further below.

FIGS. 25 and 26 show different views of the MCP positioned within the workstation. These views illustrate the orientation of the MCP in relation to the heating and cooling components on the workstation. The sample cooling region of the MCP is placed adjacent to a temperature control paddle for sample cooling. The temperature control paddle is thermally connected to a temperature control region on the integrated Main Core Device. The Main Core Device is also in thermal communication with a thermoelectric controlling (TEC) heat transfer device. Also shown are MCP Region Heaters that heat the lysing regions of the MCPs. In this example, the lysing regions are heated to about 130° C.

Summary of Sample Preparation and MCP System Fluid Flow. A biological sample is first homogenized or vortexed with binding buffer (i.e., stabilization buffer) by the user to disperse the cells. For tissue samples, the stabilization buffer is added to the sample prior to homogenization. For cells, a pellet is first formed by centrifugation, then the binding buffer is added to the pellet, and the cells are vortexed to disperse the cells in the buffer. The cell dispersion is loaded into the sample via of the MCP MCP vial using a pipette, the vial is capped, and the MCP is loaded into the workstation (FIG. 24a). With the MCP installed in the workstation, the sample is pumped under positive pressure through the filter at about 0.2 ml/min at about 130° C. to give rise to filtrate containing nucleic acids from the sample as well as other molecules. The filtrate is subsequently pumped to the sample cooling region and cooled to about room temperature. The filtrate then flows to the capture region where the nucleic acids in the filtrate bind to the capture material. For total RNA, the capture material is glass fiber paper; for genomic RNA, the capture material is glass fiber paper; and for mRNA, the capture material is oligo dT cellulose. After the nucleic acids are bound to the capture material, the bound nucleic acids are then washed to remove non-nucleic acid compounds that may have been adsorbed to the capture material. During Wash Step 1, 1 ml of Wash 1 is pumped through the Main Core Device into the MCP through the wash inlet, and then into the capture tip, to wash away unbound molecules from the capture material. During Wash 2, 1 ml of Wash 2 is pumped through the Main Core Device to wash the bound (i.e., captured) nucleic acids, to rinse away the Wash 1 (and remove salts), and to purify the nucleic acids. Subsequent to these washing steps, 4000 ml of dry air flows through the Main Core Device to dry the bound nucleic acids. The nucleic acids are then eluted from the capture material using about 0.26 (or less) ml of Elution (RNase free water) at 95° C. The nucleic acids are collected in a collection tube situated unattached to, and beneath, the MCP. The ability to obtain essentially dry and essentially salt-free nucleic acids in the molecular capture region in the elution tip is enabled according to various aspects of the present invention. In particular, temperature control of the elution tip enables this ability as well, which aids the purification and isolation of mRNA. For example, functional materials in the molecular capture region effect hybridization of mRNA. Hybridization makes use of temperature control for attaching and releasing mRNA. Binding of total RNA and genomic DNA utilizes temperature control effects as well to control the precipitation of these nucleic acids and binding onto suitable molecular capture materials. Accordingly, the MCPs and systems of the present invention suitably have multi-stage and multi-region thermal controllability. The MCPs are capable of being heated in the lysing region to lyse cells at elevated temperatures. The MCPs are also capable of being cooled in a region fluidically adjacent to the lysing region for capturing the molecules. The MCPs have elution tips that can be heated and cooled as well for binding and releasing nucleic acids. The workstation or system for manipulating the temperature, pressures, reagents, and analytes is integrated with the MCPs. The integrated system controls the flow of samples, reagents, and washes, at a variety of temperature programs as described herein for purifying and isolating molecular analytes. The MCPs and systems provided herein, in combination with suitable buffers, thermal control, and capture materials, are capable of preparing eluted sample sizes of less than about 200 microliters, even in the range of from about 10 to 50 microliters, from a single pass of a sample size up to about 5 ml. Details of the fluid loading, washing, eluting and drying programs for isolating each of genomic DNA, total RNA, and mRNA are provided in the table below.

In summary, the MCP systema described in these examples transport biological cells dispersed in a stabilization buffer specific for genomic DNA, total RNA, or mRNA, from a sample vial to an integrated lysis region on the MCP. Afterwards, the cells are lysed and flow while simultaneously filtering the nucleic acids at about 130° C. within the lysis region to form a filtrate. Subsequently, the flowing the filtrate comprising nucleic acids, stabilization buffer, and other non-nucleic acid molecules are then pumped through an integrated serpentine cooling region on the card. The filtrate is cooled to a temperature between about 20° C. and 42° C. by flowing it within the cooling region, then flowing the cooled filtrate through a capture region located within a pipette tip attached to the card. Nucleic acids are captured on the card using glass fiber (genomic DNA or total RNA) or oligo-dT-linked cellulose (mRNA) located within the capture region. As the washing solution flows, the captured nucleic acids are washed first with a buffer comprising chaotropic salts, 80% ethanol, and balance water, at to about 20° C., and second with 80/20 ethanol/water to remove buffer and salts at about 20° C. The captured nucleic acids are finally eluted to an external sample collection vial using RNase-free water at a temperature in the range of from about 65° C. to about 95° C.

The overwhelming majority of earlier sample preparation technologies utilize spin columns which are used in conjunction with a variety of centrifuge types. Using these earlier systems to prepare a biological sample for analysis in a series of steps, (typically between 15-45) are conducted at the laboratory bench by a user. A smaller subset of these technologies utilize robotic systems to pipette solutions on to affinity matrices. The development of the systems described herein, including the micropurification cards (MCP) as well as the MCP system, is a significant technical advance upon these earlier systems. While the earlier technologies have accelerated the ability to perform biological analysis, they have not taken advantage of several aspects of molecular biology. In particular, the existing systems do not adequately control the thermal, fluidic and atmospheric pressure environment that enable the efficient purification of cellular macromolecules, including but not limited to nucleic acids and proteins. The result of controlling this environment is ability to supply highly purified samples, with only trace amounts of contaminants.

This newly developed MCP system also offers a significant time savings in the preparation of biological samples as compared to the earlier technology. Depending on the application selected, the micropurification card system has demonstrated the ability to prepare samples 2-10 times faster than the earlier technologies. Without being bound to any particular theory of operation, this is accomplished by controlling the MCP environment (e.g., temperature) and eliminating a number of the incubation steps that were necessary in the previously development systems. Steps to effectively control the sample environment have been decoupled. As an example, lysing a sample using a suitable MCP and system does not require the separation of a target analyte. In this way a majority of cellular and macromolecular debris can be removed prior to a precipitation or affinity capture of a target analyte. Once trapped, the analyte can be washed under tight control, in terms of temperature, flow rate (hence pressure), and buffer composition. While the steps of the purification are decoupled, this is transparent to the user as the operator of the system. Operation of the system simply requires loading a sample on to one or more MCPs, and insert the MCPs into the slots on the MCP system to perform the purification and isolation of the target molecules.

Accordingly, the present invention allows for extreme high purity sample preparation while reducing the cost, both in terms of materials and labor, and time. The result is improved downstream biochemical analysis.

TABLE
MCP System Process Conditions for Total RNA, mRNA and Genomic DNA

| | | | | | | | | |
|---|---|---|---|---|---|---|---|---|
| Pump | #1 | #2 | #3 | Air | Flow Rate | Lyser Temp | Capture Temp | Time |
| Pump contents | Wash 1 | Wash 2 | Elution | Air | | | | |
| Units | (ml) | (ml) | (ml) | (ml) | (ml/min) | (° C.) | (° C.) | (min) |

Total RNA

| | | | | | | | | |
|---|---|---|---|---|---|---|---|---|
| Process Step | | | | | | | | |
| Sample load (user) | 0 | 0 | 0 | 0 | 0 | 60 | RT | 0 |
| Temp Ramp | 0 | 0 | 0 | 0 | 0 | 130 | 20 | 0.5 |
| Sample Push | 1 | 0 | 0 | 0 | 0.2 | 130 | 20 | 5 |
| Wash Step 1 | 1 | 0 | 0 | 0 | 0.5 | RT | 20 | 2.00 |
| Wash Step 2 | 0 | 1 | 0 | 0 | 0.5 | RT | 20 | 2.00 |
| Air Dry | 0 | 0 | 0 | 4000 | 4000 | RT | 20 | 1.00 |
| Elution Step | 0 | 0 | 0.26 | 0 | 0.3 | RT | 65 | 0.87 |
| Total Volume | 2.00 | 1.00 | 0.26 | 4000.00 | | | Total time | 11.37 |

mRNA

| | | | | | | | | |
|---|---|---|---|---|---|---|---|---|
| Process Step | | | | | | | | |
| Sample load (user) | 0 | 0 | 0 | 0 | 0 | 60 | RT | 0 |
| Temp Ramp | 0 | 0 | 0 | 0 | 0 | 130 | 20 | 0.5 |
| Sample Push | 1 | 0 | 0 | 0 | 0.2 | 130 | 20 | 5 |
| Wash Step 1 | 2 | 0 | 0 | 0 | 0.5 | RT | 42 | 4.00 |
| Wash Step 2 | 0 | 2 | 0 | 0 | 0.5 | RT | 42 | 4.00 |
| Air Dry | 0 | 0 | 0 | 4000 | 4000 | RT | 42 | 1.00 |
| Elution Step | 0 | 0 | 0.26 | 0 | 0.3 | RT | 95 | 0.87 |
| Total Volume | 3.00 | 2.00 | 0.26 | 4000.00 | | | Total time | 15.37 |

Genomic DNA

| | | | | | | | | |
|---|---|---|---|---|---|---|---|---|
| Process Step | | | | | | | | |
| Sample load (user) | 0 | 0 | 0 | 0 | 0 | 60 | RT | 0 |
| Temp Ramp | 0 | 0 | 0 | 0 | 0 | 130 | 20 | 0.5 |
| Sample Push | 1 | 0 | 0 | 0 | 0.2 | 130 | 20 | 5 |
| Wash Step 1 | 1 | 0 | 0 | 0 | 0.5 | RT | 20 | 2.00 |
| Wash Step 2 | 0 | 1 | 0 | 0 | 0.5 | RT | 20 | 2.00 |
| Air Dry | 0 | 0 | 0 | 4000 | 4000 | RT | 20 | 1.00 |
| Elution Step | 0 | 0 | 0.26 | 0 | 0.3 | RT | 95 | 0.87 |
| Total Volume | 2.00 | 1.00 | 0.26 | 4000.00 | | | Total time | 11.37 |

What is claimed:

1. A micropurification card, comprising:
a plurality of fluidic components capable of extracting molecules from a sample, the plurality of fluidic components substantially oriented in a plane, the plurality of fluidic components comprising:
a sample loading inlet,
an elution inlet,
a lysing region capable of being heated to at least about 90° C. and pressurized to at least about 10 psi greater than the ambient atmospheric pressure to provide a lysed sample,
a filter capable of filtering molecules from the lysed sample,
a molecule capture region capable of being heated to at least about 40° C., and
an elution tip,
wherein the sample loading inlet is in fluidic communication with the lysing region, the lysing region being in fluidic communication with the filter, the filter being capable of fluidically communicating one or more molecules to the molecule capture region, and the molecule capture region being in fluidic communication with both the elution inlet and the elution tip.

2. The micropurification card of claim 1, wherein the sample is naturally derived, synthetically derived, or both naturally derived and synthetically derived.

3. The micropurification card of claim 2, wherein the naturally derived molecule comprises a nucleic acid, an amino acid, a carbohydrate, a salt, a polysaccharide, or any combination thereof.

4. The micropurification card of claim 1, further comprising a sample cap capable of being sealed to the sample loading inlet, the sample cap capable of allowing fluid flow therethrough when subjected to a pressure differential, and the sample cap capable of preventing liquid flow therethrough when not subject to a pressure differential.

5. The micropurification card of claim 1, wherein two or more of the fluidic components are structurally oriented using a card-type material oriented parallel to the plane of the two or more of the fluidic components.

6. The micropurification card of claim 1, wherein the lysing region is enclosed using a filter cap oriented opposite to the filter, the filter cap and filter being oriented substantially parallel to the plane of the plurality of fluidic components.

7. The micropurification card of claim 6, wherein the filter cap is composed of a material of sufficient thermal conductivity and thinness, whereupon contact with an external heater having a contact temperature of less than about 140° C., gives rise to the fluid within the lysing region being capable of reaching a temperature greater than about 100° C. in less than about three minutes.

8. The micropurification card of claim 6, wherein the filter surface adjacent to the lysing region is characterized as being functionalized for the selective adsorption of biomolecules.

9. The micropurification card of claim 1, wherein the filter is of sufficient area to be able to filter at least about 100,000 lysed cells before clogging.

10. The micropurification card of claim 1, wherein the elution tip is characterized as being tapered to an opening smaller in size compared to a fluidic connection with the molecular capture region.

11. The micropurification card of claim 1, wherein the elution tip is characterized as having a volume of less than about 70 microliters.

12. The micropurification card of claim 11, wherein the elution tip is characterized as having a volume of greater than about 0.05 microliters.

13. The micropurification card of claim 12, wherein the elution tip comprises a pipette tip.

14. The micropurification card of claim 1, wherein the elution tip extends from a portion of the micropurification card and is capable of flowing molecules into an external sample collection vial.

15. The micropurification card of claim 1, wherein the lysing region is capable of being heated to at least about 120° C. and pressurized up to at least about 80 psi.

16. The micropurification card of claim 1, wherein the lysing region is capable of being positioned proximally adjacent to an external heater.

17. The micropurification card of claim 1, wherein the elution inlet is capable of being fluidically connected to a fluid source exterior to said micropurification card.

18. The micropurification card of claim 1, wherein the molecule capture region is capable of being heated to at least about 95° C.

19. The micropurification card of claim 18, wherein the molecule capture region is capable of being heated to about 150° C.

20. The micropurification card of claim 1, wherein the molecule capture region is capable of being cooled to at least about 4° C.

21. The micropurification card of claim 1, wherein the molecule capture region comprises an irremovable region integral to the micropurification card, a removable cartridge, or both.

22. The micropurification card of claim 21, wherein the molecule capture region comprises a capture material or capture device capable of selectively capturing one or more types of molecules that are capable of being filtered by the filter.

23. The micropurification card of claim 21, wherein the capture device comprises a micro array.

24. The micropurification card of claim 1, wherein the molecule capture region is capable of being positioned adjacent to an external heater, an external cooler, or both.

25. The micropurification card of claim 1, further comprising one or more one-way fluidic valves or channels fluidically positioned between any two or more of the fluidic components, the micropurification card being capable of fluidically transporting the molecules from the lysed sample past the molecular capture region one time.

26. A disposable micropurification card, comprising:
an injection-molded card comprising a plurality of fluidic components capable of extracting molecules from a sample, the plurality of fluidic components comprising a sample loading inlet capable of being in fluidic communication with a lysing region, the lysing region being in fluidic communication with a filter, the filter being capable of fluidically communicating one or more molecules to a molecule capture region, and the molecular capture region being in fluidic communication with an elution inlet and an elution tip.

27. The disposable micropurification card of claim 26, further comprising a sample cap capable of being sealed to the sample loading inlet, the sample cap capable of allowing fluid flow therethrough when subjected to a pressure differential, and the sample cap capable of preventing liquid flow therethrough when not subject to a pressure differential.

28. The disposable micropurification card of claim 26, wherein a portion of each of the fluidic components is provided by the injection-molded card.

29. The disposable micropurification card of claim 26, wherein the sample comprises one or more cells.

30. A system suitable for preparing samples in a micropurification card at elevated temperatures and pressures, the system comprising:
a sample input fluid connection capable of being fluidically connected under pressure to a sample loading inlet on the micropurification card;
an elution input fluid connection capable of being fluidically connected under pressure to a sample loading inlet to an elution inlet on the micropurification card;
a card holder capable of positionally holding the micropurification card to receive said sample input fluid and elution input fluid connections, the card holder comprising:
a heater capable of heating a lysing region on the micropurification card to at least about 90° C.; and
a thermal controller capable of heating a molecule capture region on the micropurification card to above about 40° C. and cooling the molecule capture region to below about 30° C.; and;
a positionable fluid collection holder capable of alternately positioning two or more collection fluid receptacles for receiving fluid exiting an elution tip on the micropurification card.

31. The system of claim 30, wherein one of the collection fluid receptacles is a waste fluid collection receptacle and another is an elutant fluid receptacle, the positionable fluid collection holder capable of being alternately slidably positioned to receive a waste fluid exiting from said elution tip into the waste fluid receptacle, or to receive an elutant fluid emanating from said elution tip into the elutant fluid receptacle.

32. The system of claim 30, wherein the thermal controller is capable of heating the molecule capture region on the micropurification card to at least about 95° C. and cooling the molecule capture region to about −20° C.

33. The system of claim 30, further comprising a scanner for reading an identification tag.

34. The system of claim 30, wherein the card holder comprises a slot for receiving said micropurification card.

35. A system suitable for collecting molecules from samples using one or more disposable micropurification cards at elevated temperatures and pressures, the system comprising:
one or more disposable micropurification cards, comprising: an injection-molded card comprising a plurality of fluidic components capable of extracting molecules from a sample comprising one or more cells, the plurality of fluidic components comprising a sample loading inlet capable of being in fluidic communication with a lysing region, the lysing region being in fluidic communication with a filter, the filter being capable of fluidically communicating one or more molecules to a molecule capture region, and the molecular capture region being in fluidic communication with an elution inlet and an elution tip; and
a system suitable for preparing samples in a micropurification card, the system comprising: a sample input fluid connection capable of being fluidically connected under pressure to the sample loading inlet on the micropurification card;
an elution input fluid connection capable of being fluidically connected under pressure to a sample loading inlet to the elution inlet on the micropurification card;
a card holder capable of holding the micropurification card in position to receive said sample input fluid and elution input fluid connections, the card holder comprising:
a heater capable of heating a lysing region on the micropurification card to at least about 90° C.; and
a thermal controller capable of heating a molecule capture region on the micropurification card to above about 40° C. and cooling the molecule capture region to below about 30° C.; and;
a positionable fluid collection holder capable of receiving an elutant fluid comprising the molecules emanating from said elution tip.

36. The system of claim 35, wherein the thermal controller is capable of heating a molecule capture region on the micropurification card to at least about 95° C. and cooling the molecule capture region to about −20° C.

37. The system of claim 35, wherein the card holder comprises a slot for receiving said micropurification card.

38. A method of collecting molecules using a card-based sample preparation system, the method comprising:
fluidically communicating a sample comprising cells and a first buffer solution under pressure from a sample loading inlet to a lysing region on a micropurification card;
heating the sample in the lysing region to a temperature in the range of from about 100° C. to about 150° C. at one or more pressures greater than ambient pressure to lyse the cells to give rise to lysed cell fragments and molecules;
filtering the molecules from the lysed cell fragments at a temperature greater than about 90° C.;
capturing at least a portion of the filtered molecules using a molecular capture material or device;
eluting at least a portion of the captured molecules using a second buffer solution through an elution tip, the second buffer solution being the same or different than the first buffer solution; and
collecting at least a portion of the eluted molecules and second buffer solution in a positionable fluid collection holder.

39. The method of claim 38, further comprising the step of inserting the micropurification card into a system suitable for preparing samples in a micropurification card.

40. The method of claim 38, wherein one or both of the buffer solutions comprise a DNase, an RNAse, an inhibitor, a salt, a buffer, a detergent, water, an organic solvent, an acid, a base, or any combination thereof.

41. A method of collecting molecules using a card-based sample preparation system, the method comprising:
fluidically communicating a sample under pressure from a sample loading inlet to a heating region on a micropurification card;
heating the sample in the heater region to a temperature in the range of from about 100° C. to about 150° C. at one or more pressures greater than ambient pressure to breakdown at least a portion of the sample;
filtering the molecules from sample fragments at a temperature greater than about 90° C.;
capturing at least a portion of the filtered molecules using a molecular capture material or device;
eluting at least a portion of the captured molecules through an elution tip; and
collecting at least a portion of the eluted molecules in a positionable fluid collection holder.

42. The method of claim 41, further comprising the step of inserting the micropurification card into a system suitable for preparing samples in a micropurification card.

43. The method of claim 41, wherein one or more buffer solutions are added to the sample before, after or both, the sample is broken down.

44. The method of claim 41, wherein one or more buffer solutions comprise a DNase, an RNAse, an inhibitor, a salt, a buffer, a detergent, water, an organic solvent, an acid, a base, or any combination thereof.

45. A method for collecting molecules from lysed cells using a card-based sample preparation system, the method comprising:
fluidically communicating a sample comprising cells and a first buffer solution under pressure from a sample loading inlet to a lysing region on a micropurification card;
lysing the cells in the lysing region using a lysing agent at one or more pressures greater than ambient pressure to give rise to lysed cell fragments and molecules;
filtering at least a portion of the molecules from the lysed cell fragments;
capturing at least a portion of the filtered molecules using a molecular capture material or device;
eluting at least a portion of the captured molecules using a second buffer solution through an elution tip, the second buffer solution being the same or different than the first buffer solution; and
collecting at least a portion of the eluted molecules and second buffer solution in a positionable fluid collection holder.

46. The method of claim 45, wherein the step of lysing cells in the lysing region further comprises heating the cells in the lysing region to a temperature up to about 150° C.

47. The method of claim 46, wherein the lysing region is heated to a temperature in the range of from about 90° C. to about 150° C.

48. The method of claim 47, wherein the cells include spores.

49. The method of claim 45, wherein at least a portion of the molecules are filtered from the lysed cell fragments at a temperature greater than about 90° C.

50. The method of claim 45, wherein the molecules include RNA, mRNA, or any combination thereof.

51. The method of claim 45, wherein RNAse inhibitors are present in the lysing region.

52. The method of claim 38, further comprising the step of inserting the micropurification card into a system suitable for preparing samples in a micropurification card.

53. The method of claim 38, wherein one or both of the buffer solutions comprise a DNase, an RNAse, an inhibitor, a salt, a buffer, a detergent, water, an organic solvent, an acid, a base, or any combination thereof.
